(19) United States
(12) Patent Application Publication
(10) Pub. No.: US 2026/0254028 A1
(43) Pub. Date: Aug. 27, 2026

(54) ENERGY STORAGE SUPPORT SYSTEM WITH PASSIVE MECHANICAL EXCITATION ATTENUATION BARRIER

(71) Applicant: SVB TECHNOLOGIES, INC., Overland Park, KS (US)

(72) Inventors: Brock Templeman, Overland Park, KS (US); Jon Templeman, Overland Park, KS (US)

(21) Appl. No.: 19/545,822

(22) Filed: Feb. 20, 2026

Related U.S. Application Data
(60) Provisional application No. 63/761,324, filed on Feb. 21, 2025.

(51) Int. Cl. H01M 50/242; H01M 50/14; H01M 50/244

(52) U.S. Cl. CPC H01M 50/242; H01M 50/14; H01M 50/244

(57) ABSTRACT

An integrated battery assembly includes a battery component having internal energy storage components and an enclosure; and a shock and vibration barrier that supports the battery component and provides a primary mechanical load path between the battery component and an external support structure. The shock and vibration barrier has a shock and vibration absorbing pad with at least one passive mechanically compliant isolator that attenuates transmission of shock or vibration to the battery component.

### CROSS-REFERENCE TO RELATED APPLICATIONS

The current patent application is a U.S. Non-provisional Patent Application which claims priority benefit, with regard to all common subject matter expressly or inherently disclosed, of earlier-filed U.S. Provisional Patent Application Serial No. 63/761324, titled “ELECTRIC VEHICLE (EV) BATTERY MODULE” and filed February 21, 2025. The earlier-filed patent application is hereby incorporated by reference, in its entirety, into the current patent application.

### BACKGROUND OF THE INVENTION

Energy storage devices are implemented in a wide variety of architectures, including individual batteries, battery modules comprising multiple electrochemical cells, and battery assemblies comprising one or more battery modules and optionally including associated structural, electrical, thermal management, control, enclosure, or mounting components. These architectures may vary significantly in size, mass, geometry, internal construction, packaging configuration, and intended application.

Despite differences in architecture, many batteries, battery modules, and battery assemblies exhibit sensitivity to mechanical excitation. Internal components such as electrodes, separators, current collectors, interconnects, fasteners, sensors, and control elements may be susceptible to displacement, fatigue, or degradation when subjected to transient or sustained mechanical loading. Mechanical excitation may also affect alignment of cells, integrity of electrical and thermal interfaces, and long-term electrochemical performance.

As energy storage systems increase in energy density, power density, and integration complexity, managing mechanical excitation becomes increasingly important. At the same time, constraints related to weight, packaging volume, manufacturability, cost, and efficient utilization of structural materials and critical raw materials limit the extent to which structural rigidity alone can be increased without adverse trade-offs.

Mechanical excitation experienced by batteries, battery modules, and battery assemblies may include transient events, sustained dynamic excitation, broadband excitation, resonant excitation, impulse loading, or combinations thereof. Shock events typically involve high-amplitude, short-duration inputs that may arise from impacts, drops, handling events, installation forces, or transient operating conditions. Such events may impose inertial loads that exceed nominal design limits.

Vibration typically involves lower-amplitude, sustained excitation across a range of frequencies. Such excitation may arise from vehicle operation, rotating machinery, transportation, seismic activity, environmental sources, or nearby equipment. Prolonged dynamic excitation may lead to cumulative fatigue, loosening of fasteners, fretting, and gradual degradation of internal components.

In many real-world applications, batteries and other energy storage devices are subjected to multiple forms of mechanical excitation, sometimes simultaneously. Effective mitigation therefore requires solutions capable of addressing diverse excitation modes without introducing new structural vulnerabilities or unintended load paths.

Mechanical excitation may contribute to a range of failure modes in energy storage devices. These may include deformation or cracking of housings, loosening of electrical connections, degradation of cell interfaces, misalignment of internal components, damage to sensors or control electronics, and compromised thermal pathways.

In some cases, mechanical excitation may exacerbate thermal stress by altering heat transfer characteristics, impairing cooling system alignment, and/or introducing localized deformation that affects thermal interfaces. Over time, repeated exposure to mechanical excitation may reduce usable capacity, increase internal resistance, shorten service life, and necessitate early replacement of the battery, battery module, or battery assembly. Because such degradation mechanisms may develop gradually and may not be immediately detectable during initial deployment, long-term reliability, lifecycle performance, maintenance planning, and total cost of ownership may be adversely affected.

Conventional approaches to managing mechanical excitation in batteries, battery modules, and battery assemblies often focus on increasing the mechanical robustness of internal components so that such components can endure shock, vibration, or other forms of mechanical excitation. Such approaches may include thicker current collectors, reinforced electrode structures, additional internal supports, heavier housings, increased fastener counts, expanded structural members, and conservative mechanical design margins intended to allow internal components to withstand transmitted mechanical loads.

While such internal reinforcement strategies may improve durability under certain conditions, they frequently increase system cost, mass, and material consumption. Increased internal robustness may require additional conductive materials, structural metals, polymers, and other raw materials, including critical minerals, which may reduce gravimetric and volumetric energy density and increase manufacturing complexity. Increased material usage may also impact supply chain efficiency, lifecycle cost, and overall resource utilization of the battery, battery module, or battery assembly.

Moreover, designing internal components to endure repeated mechanical excitation does not necessarily eliminate degradation mechanisms associated with shock, vibration, or combined loading conditions. In some cases, such approaches may instead redistribute mechanical stresses within the battery, battery module, or battery assembly without materially reducing transmitted excitation. Over time, repeated exposure to mechanical excitation may still contribute to fatigue-related damage, gradual performance degradation, reduced usable capacity, and shortened service life. Accordingly, internal reinforcement strategies may increase cost and material usage without fully addressing long-term reliability or lifecycle efficiency.

Modern battery technologies rely on a range of raw materials and critical minerals, including, but not limited to, lead, lithium, nickel, cobalt, manganese, copper, aluminum, graphite, and other conductive or structural materials. Many of these materials are subject to geopolitical constraints, supply chain concentration, price volatility, regulatory considerations, and national security implications. Efforts to increase internal mechanical robustness of batteries, battery modules, or battery assemblies may require additional quantities of such materials, potentially increasing exposure to supply chain risk, cost variability, and environmental impacts associated with extraction, refining, processing, and transportation.

In addition, internal over-engineering intended to improve resistance to mechanical excitation may reduce the efficiency with which structural materials and critical minerals are utilized within a battery, battery module, or battery assembly. Increased material intensity may limit the number of energy storage devices that can be produced from a given resource base and may increase lifecycle material demand due to replacement associated with mechanically induced degradation. Accordingly, approaches that rely primarily on increasing internal robustness may not optimize long-term material efficiency, sustainability objectives, or overall system economics.

Rigid mounting structures are commonly used to secure batteries, battery modules, and battery assemblies within vehicles, racks, enclosures, and other supporting systems. While rigid mounts may provide positional stability and structural support, such configurations often transmit mechanical excitation - including shock and vibration - directly from the supporting structure to the energy storage device. In certain operating environments, this direct transmission may increase the mechanical loads experienced by internal components of the battery, battery module, or battery assembly.

In some configurations, rigid mounting structures may amplify certain frequency components of mechanical excitation and may concentrate loads at discrete attachment points. Such load concentrations may increase localized stresses within a battery, battery module, or battery assembly, depending on system geometry and operating conditions. Efforts to further stiffen mounting structures in order to manage such loads may introduce trade-offs relating to packaging constraints, weight, manufacturability, cost, and material utilization. Accordingly, reliance solely on rigid mounting strategies may not address all mechanical excitation scenarios encountered across diverse operating environments.

In certain implementations, battery support systems may include elastomeric pads, grommets, foams, bushings, or similar compliant elements intended to provide some degree of vibration mitigation. Such elements are often incorporated as secondary or supplemental features rather than as primary load-bearing structures within the mechanical support architecture. As a result, a substantial portion of static and dynamic mechanical loads may be transmitted through more rigid structural pathways, with the compliant elements providing only limited influence over the primary mechanical load path between the energy storage device and the supporting structure.

While incidental elastomeric elements may provide limited damping or compliance, they are frequently not configured or dimensioned to function as part of the primary mechanical load path between the battery component and the external support structure. In many implementations, static and dynamic loads are transmitted predominantly through rigid structural members, with compliant elements contributing only secondary compliance outside the primary mechanical load path. As a result, attenuation performance may be inconsistent, unpredictable, or highly dependent on installation conditions. In addition, elastomeric materials may experience degradation over time due to compression set, fatigue, temperature cycling, environmental exposure, or sustained loading, potentially altering stiffness characteristics and reducing attenuation effectiveness throughout the operational lifecycle.

Active isolation systems may employ sensors, actuators, control electronics, and associated algorithms to counteract mechanical excitation. While such systems may attenuate mechanical excitation under certain controlled conditions, they may introduce additional complexity, cost, weight, packaging constraints, power consumption, and potential failure modes. Active systems may also depend on sensor accuracy, response latency, control stability, and ongoing calibration, and may present challenges in attenuating high-amplitude transient mechanical excitation. In many battery-based applications, including, but not limited to, mobile, transportation, and stationary energy storage deployments, the added system complexity, energy requirements, and integration burden associated with active isolation may be undesirable or impractical.

Battery technologies continue to evolve rapidly with respect to chemistry, size, weight, form factor, packaging architecture, internal construction, and integration strategy. Energy storage devices may be implemented using a wide range of electrochemical systems, structural configurations, modular arrangements, and enclosure designs, both currently available and yet to be developed. Mechanical support and isolation solutions that are tightly coupled to a particular chemistry, mass range, geometry, enclosure configuration, or packaging constraint may lack adaptability as battery technologies evolve. Accordingly, there remains a need for mechanical support architectures that are substantially chemistry-agnostic, form-factor agnostic, and scalable across multiple battery types, sizes, and deployment contexts without requiring redesign of internal electrochemical components.

Modern energy storage deployments increasingly emphasize modularity, scalability, serviceability, and lifecycle management. Batteries, battery modules, and battery assemblies may be transported, installed, commissioned, serviced, relocated, reconfigured, repurposed, and redeployed multiple times over their usable life. Mechanical support solutions that are effective only in a single mounting configuration, orientation, or lifecycle stage may be insufficient for such evolving deployment models. Accordingly, there remains a need for adaptable mechanical support architectures capable of maintaining a primary mechanical load path and consistent attenuation of mechanical excitation across multiple installation configurations, operating conditions, and lifecycle phases with or without requiring modification of internal electrochemical components.

In many conventional mounting configurations, mechanical support and mechanical excitation mitigation functions are not architecturally unified. Rigid structural members may provide the primary mechanical load path, while the compliant elements, if present, function as secondary or incidental features. In such arrangements, mechanical excitation may be transmitted through unintended or partially mitigated bypass paths that circumvent compliant elements. The presence of parallel load paths may reduce predictability of system response and limit the effectiveness of mechanical excitation attenuation under dynamic loading conditions. There remains a need for support architectures in which attenuation of mechanical excitation occurs at least in part within the primary mechanical load path itself, thereby enabling more controlled, predictable, and tunable system behavior.

In many deployment environments including, but not limited to, automotive systems, stationary energy storage installations, industrial equipment, transportation platforms, marine systems, aerospace systems, and other applications, packaging constraints associated with batteries, battery modules, and battery assemblies are significant. Available installation space may be shared with structural, thermal, electrical, and other subsystems, and mechanical support solutions must accommodate limitations related to dimensions, weight, and/or internal volumetric capacity. Efforts to increase structural robustness or add supplemental isolation features may conflict with objectives related to system integration, energy density, and/or deployment flexibility. There remains a need for mechanical support architectures that integrate structural support and mechanical excitation mitigation in a manner that preserves packaging efficiency while enabling predictable and tunable attenuation of mechanical excitation across diverse applications and operating conditions.

Energy storage systems are deployed across a wide range of voltage classes and application domains, including, but not limited to, low-voltage systems, high-voltage systems, traction systems, stationary storage systems, industrial power systems, and mobile platforms. Such systems may operate under diverse system configurations and/or deployment environments, including variations in mounting orientation, structural interface, environmental exposure, transportation conditions, and/or operational duty cycles. There remains a need for mechanical support and attenuation architectures that are adaptable across voltage classes, chemistries, sizes, and/or form factors while maintaining consistent attenuation of mechanical excitation within a primary mechanical load path.

### SUMMARY OF THE INVENTION

The present invention provides systems, assemblies, barriers, and methods for supporting a battery selected from the group consisting of a battery, a battery module, and a battery assembly while attenuating mechanical excitation transmitted from an external support structure. In various embodiments, the invention integrates one or more passive mechanically compliant elements into a mechanical excitation attenuation barrier that establishes a primary mechanical load path between the battery and the external support structure such that mechanical excitation is attenuated within the primary mechanical load path itself.

In accordance with one or more embodiments, the invention includes a passive mechanical excitation attenuation barrier configured to provide a primary mechanical load path between a battery, battery module, or battery assembly and an external support structure. The mechanical excitation attenuation barrier comprises at least one isolator including at least one passive mechanically compliant element configured to attenuate transmission of mechanical excitation to the battery, battery module, or battery assembly. The mechanical excitation attenuation barrier is configured to support static loads, dynamic loads, and/or combined loading conditions while attenuating mechanical excitation transmitted from the external support structure, thereby forming, together with the battery, battery module, or battery assembly, a passive isolation system.

The mechanical excitation attenuation barrier is architecturally distinct from incidental damping elements and is integrated into the structural support architecture of the system such that attenuation of mechanical excitation occurs within the primary mechanical load path. By defining and controlling the primary mechanical load path through the mechanical excitation attenuation barrier, transmission of unmitigated mechanical excitation to the battery, battery module, or battery assembly may be reduced, controlled, and/or predictably tuned under static, dynamic, and/or combined loading conditions. This load-path-centric architecture enables more consistent system-level mechanical behavior across varying operating environments and installation configurations.

Unlike conventional approaches that increase internal mechanical robustness of battery components to endure mechanical excitation, the systems described herein mitigate mechanical excitation externally through a mechanical excitation attenuation barrier that forms the primary mechanical load path. By attenuating shock, vibration, and/or other mechanical excitation before transmission into the battery, battery module, or battery assembly, internal architectures may be optimized for electrochemical performance, manufacturing efficiency, weight reduction, material utilization, and/or packaging efficiency rather than mechanical survivability alone. As a result, internal components may be configured with reduced structural overdesign, potentially lowering material consumption, preserving critical raw materials, reducing mass, and/or decreasing mechanically induced degradation over the service life of the energy storage device.

In various embodiments, the mechanical excitation attenuation barrier comprises one or more isolators and/or other passive mechanically compliant elements arranged to support a battery, battery module, or battery assembly while attenuating transmission of mechanical excitation. The isolators may be configured in single-point, multi-point, distributed, perimeter, and/or continuous arrangements, and may be selected and/or tuned based on characteristics including, but not limited to, geometry, material selection, stiffness, damping behavior, durometer, preload conditions, mass distribution, contact area, internal structure, spatial orientation, and/or placement relative to the supported energy storage device. The isolators may be configured to provide isotropic or anisotropic compliance and may be arranged to support static, dynamic, and/or combined loading conditions within the primary mechanical load path.

The mechanical excitation attenuation barrier may be implemented as an integrated structural feature of a battery, battery module, or battery assembly; as a discrete support assembly positioned between the battery, battery module, or battery assembly and an external support structure; as an adapter, retrofit, and/or interface structure for existing installations; and/or as a modular component suitable for use across multiple system configurations. In some embodiments, the mechanical excitation attenuation barrier is externally visible when installed. In other embodiments, the mechanical excitation attenuation barrier is partially or fully concealed within surrounding structures. The visibility or concealment of the mechanical excitation attenuation barrier does not alter its function as a primary mechanical load path configured to attenuate mechanical excitation.

The systems and methods described herein are applicable to a battery, battery module, or battery assembly of varying sizes, weights, chemistries, voltages, capacities, packaging architectures, and form factors, including both presently known and future-developed energy storage technologies. The mechanical excitation attenuation barrier enables adaptation to different mounting orientations, structural interfaces, environmental conditions, and lifecycle phases with or without requiring redesign or structural reinforcement of internal electrochemical components. By architecturally separating mechanical excitation attenuation from internal electrochemical design, the disclosed systems support scalability, modularity, and long-term technology evolution.

Because the mechanical excitation attenuation barrier operates passively, the disclosed systems do not rely on sensors, actuators, active control algorithms, feedback loops, or external power sources to achieve attenuation of mechanical excitation. The passive architecture may reduce system complexity, integration burden, packaging volume, cost, and energy consumption while minimizing potential failure modes associated with active components. The absence of dedicated control hardware, power electronics, and sensor systems may further simplify implementation across mobile, transportation, stationary, and industrial applications while providing consistent and predictable attenuation performance across a wide range of operating environments and duty cycles.

The invention further provides methods for configuring, tuning, and adapting the mechanical excitation attenuation barrier to accommodate different system requirements, including, but not limited to, transportation, installation, normal operation, servicing, relocation, redeployment, and/or changes in supported battery, battery module, or battery assembly configuration. Such configuration may be performed at the time of manufacture, installation, and/or post-installation through selection, adjustment, replacement, and/or reconfiguration of barrier components and/or isolator characteristics, including, but not limited to, geometry, material properties, durometer, stiffness, damping behavior, preload, spatial arrangement, interface features, and/or other mechanical attributes.

By providing a passive, load-bearing mechanical excitation attenuation barrier positioned within a primary mechanical load path between a battery, battery module, or battery assembly and an external support structure, the invention enables reduced material consumption, lower system cost, extended service life, and/or improved mechanical resilience of energy storage systems. Because attenuation of mechanical excitation occurs externally rather than through internal structural over-engineering, internal electrochemical components may be optimized for energy density, manufacturability, and/or efficient use of raw materials, including critical minerals, while maintaining durability under expected operating conditions. The disclosed architecture thereby supports improved lifecycle efficiency and/or adaptability across diverse deployment environments without reliance on active isolation components.

The systems described herein enable more efficient utilization of battery materials, including critical minerals, by reducing unnecessary structural overdesign and extending usable service life. By attenuating mechanical excitation externally within a primary mechanical load path, the systems reduce the need for internal components of a battery, battery module, or battery assembly to be engineered primarily for mechanical endurance. This architectural separation permits internal electrochemical components to be optimized for electrochemical performance, energy density, manufacturability, and/or material efficiency rather than structural survivability under mechanical excitation.

By providing external attenuation of mechanical excitation within a primary mechanical load path, the systems described herein enable internal battery architectures to evolve independently of mechanical support constraints. This architectural separation allows optimization of electrochemical performance, manufacturing processes, packaging efficiency, and/or material utilization across current and future battery technologies. The mechanical excitation attenuation barrier may minimize unintended bypass paths and enable predictable, repeatable, and tunable system-level mechanical behavior across transportation, installation, storage, and operational conditions. The systems are adaptable to different battery, battery module, or battery assembly architectures and scalable across sizes, weights, chemistries, and/or deployment environments without reliance on active control components or excessive packaging volume.

The systems described herein are adaptable and substantially agnostic to internal electrochemical design and internal structural architecture of a battery, battery module, or battery assembly. Because attenuation of mechanical excitation occurs within a primary mechanical load path external to the internal electrochemical components, the mechanical excitation attenuation barrier may remain effective across multiple generations of energy storage devices without requiring redesign of internal cell structures or electrochemical configurations. The barrier may maintain consistent attenuation performance across manufacturing, transportation, installation, operation, servicing, relocation, and/or redeployment lifecycle phases, and may be adjusted, replaced, or tuned independently of the energy storage device itself.

In one example embodiment, the mechanical excitation attenuation barrier may be externally attached to a battery, battery module, or battery assembly and may comprise one or more mechanically compliant elements arranged to attenuate mechanical excitation while providing a primary mechanical load path. In certain embodiments, the barrier may include a mechanically compliant pad structure, a support structure such as a base plate, one or more retention structures, and/or one or more isolators. It should be understood that a pad structure represents one possible configuration of the mechanical excitation attenuation barrier and is not required in all embodiments.

In embodiments including a mechanically compliant pad structure, the pad may interface with the battery, battery module, or battery assembly and provide mechanical excitation attenuation within the primary mechanical load path. A support structure, such as a base plate or other structural member, may support the barrier assembly within a vehicle, rack, enclosure, or other external support structure. One or more retention structures may secure the mechanically compliant element relative to the support structure. Optional upper structural elements may provide additional stabilization, enclosure, or branding surfaces. The specific configuration of such components may vary without departing from the scope of the mechanical excitation attenuation barrier architecture.

In certain embodiments, the mechanically compliant pad structure may comprise a compressible material, including, but not limited to, polyurethane, elastomeric materials, rubber, thermoplastic polyurethane, or combinations thereof. The pad may include a lower surface configured to interface with a support structure and an upper surface configured to interface with the battery, battery module, or battery assembly. In some embodiments, the pad may include an upstanding lip or perimeter structure configured to space the battery from adjacent structural elements so that mechanical excitation transmitted from the external support structure is attenuated through the mechanically compliant material rather than transmitted through a rigid mechanical bypass path. It should be understood that such lip structures are optional and represent one implementation of the broader mechanical excitation attenuation barrier.

In certain embodiments, the mechanical excitation attenuation barrier may include at least one isolator extending from a mechanically compliant element, such as a pad structure, or formed integrally therewith. The at least one isolator may be configured to provide controlled stiffness characteristics and to contribute to formation of a passive isolation system having a selected natural frequency. The quantity, size, geometry, and/or material properties of the at least one isolator may be selected or tuned to achieve desired mechanical excitation attenuation performance for batteries, battery modules, or battery assemblies of varying sizes, masses, and/or configurations. In some embodiments, additional mechanically compliant features may be provided to address higher-amplitude transient excitation events. Such features are optional and may be implemented in various geometries without limiting the broader barrier architecture.

In certain embodiments, the mechanical excitation attenuation barrier may further comprise one or more auxiliary compliant features configured to engage under selected loading conditions. Such auxiliary compliant features may be positioned relative to at least one isolator so that, during typical operating conditions, primary load support is provided through the at least one isolator. Under higher-magnitude transient mechanical excitation, including, but not limited to, impact events or other impulse loading conditions, the auxiliary compliant features may engage to provide additional load distribution, progressive stiffness, energy dissipation, and/or deflection control. The quantity, geometry, material composition, and/or spatial arrangement of such auxiliary compliant features may be selected, tuned, or configured to achieve desired attenuation characteristics while maintaining the primary mechanical load path through the mechanical excitation attenuation barrier.

In certain embodiments, at least a portion of the mechanical excitation attenuation barrier may be externally visible when installed. External visibility may provide an indication of the presence of mechanical excitation attenuation and may facilitate inspection, identification, servicing, and/or differentiation of the supported energy storage device. In other embodiments, the mechanical excitation attenuation barrier may be partially or fully concealed within adjacent structural elements. The degree of visibility does not affect the functional capability of the mechanical excitation attenuation barrier to provide attenuation of mechanical excitation within a primary mechanical load path.

In certain embodiments, the mechanical excitation attenuation barrier may be configured to occupy a limited volumetric envelope relative to the battery, battery module, or battery assembly. The mechanical excitation attenuation barrier may be structured so as not to materially increase external dimensions, mounting footprint, or packaging constraints of the supported energy storage device. In some embodiments, the mechanical excitation attenuation barrier may be positioned within a recessed region, channel, perimeter feature, or other structural interface such that overall system integration is preserved. However, dimensional impact may vary depending on application requirements, and no particular dimensional relationship is required unless expressly recited in the claims.

This Summary of the Invention is provided to introduce, in simplified form, certain concepts that are further described below in the Detailed Description. This Summary is not intended to identify key features, essential features, or required elements of any claimed subject matter, nor is it intended to be used to limit the scope of the claims. The invention encompasses various systems, assemblies, structures, barriers, and methods as described herein, individually and in combination, including those directed to integrated energy storage support assemblies, mechanical excitation attenuation barriers, battery support systems, and methods of configuring passive mechanical excitation attenuation systems. The scope of protection is defined solely by the claims as ultimately allowed.

### BRIEF DESCRIPTION OF DRAWINGS

Embodiments of the present invention are described below with reference to the accompanying drawing figures, wherein like reference numerals may refer to like elements across figures. The drawing figures illustrate representative embodiments of mechanical excitation attenuation barriers, integrated energy storage support assemblies, and associated components.

FIG. 1 is a perspective view of an example integrated energy storage assembly comprising a battery component and a mechanical excitation attenuation barrier constructed in accordance with one embodiment of the present invention and shown in an assembled configuration.

FIG. 2 is an exploded perspective view of the integrated energy storage assembly of FIG. 1, illustrating example components of the mechanical excitation attenuation barrier and their relationship to the battery component.

FIG. 3 is an additional exploded view of the embodiment shown in FIGS. 1 and 2, further illustrating structural relationships between the battery component and the mechanical excitation attenuation barrier.

FIG. 4 is a top perspective view of an example embodiment of a mechanical excitation attenuation element configured as a compliant support structure, which in certain embodiments may take the form of a pad including one or more isolators.

FIG. 5 is a fragmentary sectional view of the example embodiment shown in FIG. 4, illustrating representative isolator structures and associated mechanical excitation attenuation features.

The drawing figures are provided to illustrate representative embodiments and principles of the invention and are not intended to limit the scope of the claimed subject matter. The drawings are not necessarily to scale, and certain features may be exaggerated, simplified, or omitted for clarity. Various alternative embodiments and configurations may be implemented without departing from the scope of the claims.

### DESCRIPTION OF EMBODIMENTS OF INVENTION

Embodiments of systems, structures, and methods for supporting a battery selected from the group consisting of a battery, a battery module, and a battery assembly will now be described with reference to the attached drawing figures. Unless otherwise specified, references to a “battery,” an “energy storage device,” or a similar object are intended to encompass a battery, a battery module, and/or a battery assembly. The disclosed embodiments support the battery while attenuating mechanical excitation transmitted from an external environment, an external support structure, and/or an operating system. As used herein, the term “mechanical excitation” includes, without limitation, shock, vibration, impulse loading, transient mechanical loading, sustained dynamic loading, resonant excitation, broadband excitation, and combinations thereof. The terms “force,” “load,” or “mechanical load” refer to static, dynamic, and/or combined loading conditions that may be transmitted to the battery during transportation, installation, operation, servicing, relocation, or other lifecycle phases. Additional definitions and interpretive guidance are set forth below to clarify terminology used throughout this description.

One embodiment of the invention is an integrated energy storage support assembly broadly comprising a battery 10 and a mechanical excitation attenuation barrier 12 structurally interposed between the battery and an external support structure, such as a vehicle frame, equipment chassis, battery rack, installation platform, or other structural interface. The mechanical excitation attenuation barrier supports the battery and bears static, dynamic, and/or combined mechanical loads associated with the weight of the battery, operational forces, transportation-induced loading, environmental excitation, and installation or handling events. In the illustrated embodiment, the mechanical excitation attenuation barrier 12 is positioned between the battery 10 and the external support structure such that mechanical loads transmitted between the battery and the external support structure are routed through the mechanical excitation attenuation barrier.

Unlike conventional elastomeric pads or incidental compliance features, the mechanical excitation attenuation barrier is architected as an intentional structural element within the load-bearing system. Mechanical loads transmitted between the battery and the external support structure are routed through the mechanical excitation attenuation barrier rather than bypassing the barrier through rigid secondary load paths. The mechanical excitation attenuation barrier provides a primary mechanical load path between the battery and the external support structure. As used herein, a “primary mechanical load path” refers to the principal route through which operational mechanical loads are predominantly transmitted during normal use and foreseeable operating conditions.

The mechanical excitation attenuation barrier may coexist with secondary or incidental load paths, including, but not limited to, electrical connections, thermal interfaces, auxiliary supports, fasteners, and/or structural alignment features. However, such secondary load paths are not required to carry a majority of the mechanical load transmitted between the battery and the external support structure and do not defeat the role of the mechanical excitation attenuation barrier as the primary mechanical load path. Because the mechanical excitation attenuation barrier defines the primary mechanical load path, attenuation of mechanical excitation occurs within the principal structural interface through which operational mechanical loads are predominantly transmitted.

Mechanical excitation acting on the battery may be applied along one or more axes, including vertical, lateral, longitudinal, rotational, and/or combined directions. In one or more embodiments, the mechanical excitation attenuation barrier is configured to attenuate mechanical excitation along a single axis. In other embodiments, the mechanical excitation attenuation barrier is configured to attenuate mechanical excitation along multiple axes. The mechanical excitation attenuation barrier may therefore be configured to provide directional compliance that is isotropic or anisotropic, depending on application requirements and expected loading conditions.

As disclosed in more detail below, the mechanical excitation attenuation barrier includes at least one isolator 48 comprising at least one passive mechanically compliant element configured to attenuate transmission of mechanical excitation. The at least one isolator 48 may be arranged and configured to provide anisotropic and/or isotropic mechanical compliance, depending on application requirements. For example, in certain embodiments, the at least one isolator 48 provides greater compliance in a vertical direction while maintaining relatively increased stiffness in one or more lateral and/or longitudinal directions to support packaging constraints, positional stability, and/or handling requirements of the battery, battery module, or battery assembly.

Multi-axis embodiments may be configured such that the mechanical excitation attenuation barrier attenuates mechanical excitation resulting from complex loading conditions, including combined vertical and lateral excitation, torsional loads, rotational inputs, impulse events, and/or transient impact events. The configuration of the at least one isolator 48 may be selected, arranged, and/or tuned to balance load-bearing capability with attenuation performance across expected operating conditions. In certain embodiments, compliance characteristics may be directionally differentiated to provide enhanced attenuation along selected axes while maintaining sufficient stiffness along other axes to preserve alignment, stability, and structural integrity of the battery, battery module, or battery assembly.

The mechanical excitation attenuation barrier, in combination with the battery, battery module, or battery assembly, forms a passive mechanical isolation system having one or more natural frequencies. In certain embodiments, the passive isolation system is configured to achieve, target, select, and/or maintain a natural frequency at or below a predetermined threshold, such as approximately 200 Hz or less, under expected operating and loading conditions. The natural frequency of the combined system may be influenced by characteristics including, but not limited to, mass distribution, isolator stiffness, damping behavior, geometry, preload conditions, and structural arrangement within the primary mechanical load path.

By appropriate selection and arrangement of the at least one isolator within the primary mechanical load path, the mechanical excitation attenuation barrier attenuates transmission of mechanical excitation across one or more frequency ranges of interest. Adjustment of stiffness, damping, geometry, material properties, preload conditions, and/or spatial distribution of the at least one isolator may be used to influence transmissibility characteristics of the passive isolation system. In certain embodiments, this configuration reduces amplification of mechanical excitation near resonant frequencies and mitigates the effects of shock, vibration, and/or combined dynamic loading encountered during transportation, installation, operation, servicing, relocation, or other lifecycle phases.

In some embodiments, the mechanical excitation attenuation barrier is configured to attenuate mechanical excitation within one or more frequency ranges associated with vehicle operation, transportation, industrial machinery, stationary installations, seismic activity, handling events, and/or environmental excitation, while maintaining sufficient structural stiffness to support the battery, battery module, or battery assembly as part of the primary mechanical load path. The mechanical excitation attenuation barrier may be configured to balance load-bearing capacity and attenuation performance such that the supported energy storage device remains structurally stable while transmissibility of mechanical excitation is reduced within selected operational frequency bands.

In one or more embodiments, the mechanical excitation attenuation barrier provides mechanical support for the battery, battery module, or battery assembly independently of electrical interfaces associated with the energy storage system. Electrical conductors, terminals, bus bars, sensing leads, thermal interface components, or other electrical or electronic elements are not required to carry structural loads transmitted through the mechanical excitation attenuation barrier. In this manner, structural load transfer and electrical connectivity are architecturally separated, such that mechanical excitation attenuation occurs within the primary mechanical load path without imposing unintended mechanical stress on electrical components.

Separation of mechanical load transfer from electrical and electronic subsystems reduces mechanically induced stress on conductors, interconnects, terminals, sensing elements, and associated circuitry, thereby enhancing durability, reliability, and long-term performance. Electrical components may be routed, supported, retained, or integrated independently of the mechanical excitation attenuation barrier without interfering with the primary mechanical load path or the attenuation of mechanical excitation. This architectural separation permits optimization of electrical, thermal, and structural subsystems according to their respective design requirements while maintaining consistent mechanical excitation attenuation performance.

The disclosed embodiments are compatible with a wide range of packaging constraints associated with batteries, battery modules, and battery assemblies of differing sizes, shapes, chemistries, masses, and form factors. The mechanical excitation attenuation barrier may be sized, shaped, contoured, segmented, or otherwise configured to occupy a limited volumetric envelope relative to the supported energy storage device while preserving a primary mechanical load path and effective attenuation of mechanical excitation. In certain embodiments, the barrier is configured to minimize impact on available internal electrochemical volume, overall footprint, height, and/or integration interfaces.

The mechanical excitation attenuation barrier may be implemented as a retrofit component, integrated into an existing support structure, incorporated into a newly designed housing, tray, rack, enclosure, structural interface, or other supporting structure, including, but not limited to, vehicle frames, chassis members, mounting brackets, or installation platforms, or provided as a modular assembly adaptable to multiple configurations. The architecture supports modular, scalable, and custom battery, battery module, and battery assembly configurations and may not require modification of internal electrochemical components in order to achieve attenuation of mechanical excitation within the primary mechanical load path.

During operation, mechanical loads acting on the battery, battery module, or battery assembly are transmitted through the mechanical excitation attenuation barrier as the primary mechanical load path. Mechanical excitation originating from the external support structure is attenuated by the at least one passive mechanically compliant isolator before being transmitted to the battery, battery module, or battery assembly. This system-level behavior may persist throughout transportation, installation, operation, servicing, relocation, storage, and other lifecycle phases. The architecture does not rely on active control systems, sensors, actuators, control algorithms, or external power sources to achieve attenuation of mechanical excitation.

The system architectures described herein are applicable to batteries, battery modules, and battery assemblies deployed across a wide range of application domains, including, but not limited to, electric vehicles, hybrid vehicles, stationary energy storage systems, transportation platforms, industrial equipment, marine systems, aerospace platforms, robotics systems, and infrastructure-mounted installations. In each context, the mechanical excitation attenuation barrier may be configured to provide a primary mechanical load path while attenuating transmission of mechanical excitation to the supported battery, battery module, or battery assembly.

The mechanical excitation attenuation barrier may be adapted to different battery chemistries, sizes, weights, form factors, mounting orientations, and/or operating environments while preserving the architectural principles described herein, including provision of a primary mechanical load path and attenuation of mechanical excitation within that load path. Such adaptability enables implementation across evolving battery technologies without requiring redesign of internal electrochemical components or internal structural architectures.

In some embodiments, the system is configured to reduce, control, or eliminate rigid mechanical bypass paths between the battery, battery module, or battery assembly and the external support structure that would otherwise circumvent the mechanical excitation attenuation barrier. Such configuration may include positioning at least one isolator within the primary mechanical load path, arranging support and retention structures to discourage parallel rigid load transfer, and/or ensuring that any additional structural interfaces remain non-load-bearing or mechanically compliant with respect to operational mechanical loads. By limiting unintended rigid pathways, attenuation of mechanical excitation occurs predominantly within the intended load-bearing isolation architecture.

In one or more embodiments, the mechanical excitation attenuation barrier 12 comprises a mechanically compliant support member, such as a pad 28 or other compliant structure, upon or within which at least one isolator 48 is formed, coupled, or otherwise supported. In the illustrated embodiment, the mechanical excitation attenuation barrier 12 further includes a support structure, such as a base plate 30 configured to interface with an external support structure, and one or more retention structures 32, 34 configured to capture, retain, or position the pad 28 relative to the base plate 30. The pad 28, the at least one isolator 48, the base plate 30, and the retention structures 32, 34 may be provided as separate components, partially integrated components, or a monolithic structure, depending on manufacturing and application requirements. In all such embodiments, the at least one isolator 48 is positioned within the primary mechanical load path so that mechanical excitation transmitted from the external support structure to the battery, battery module, or battery assembly is attenuated through the mechanically compliant architecture.

In operation, the mechanical excitation attenuation barrier 12 provides a primary mechanical load path between the battery component 10 and an external support structure. Static, dynamic, and/or combined mechanical loads acting on the battery component 10 during transportation, installation, operation, servicing, relocation, or other lifecycle phases are transmitted through the mechanical excitation attenuation barrier 12. Mechanical excitation, including shock, vibration, or combinations thereof, originating from the external support structure is attenuated by the at least one passive mechanically compliant isolator 48 before being transmitted to the battery component 10. Because attenuation occurs within the primary mechanical load path, transmission of unmitigated mechanical excitation to the battery component 10 is reduced, thereby enabling predictable and tunable system behavior without reliance on active control elements.

The mechanical excitation attenuation barrier 12 may be provided as a standalone component configured for installation between a battery component 10 and an external support structure, or may be integrated into a housing, tray, rack, enclosure, vehicle structure, industrial frame, mounting interface, or other support architecture. In some embodiments, the mechanical excitation attenuation barrier 12 is externally positioned relative to a shell or enclosure of the battery component 10. In other embodiments, the mechanical excitation attenuation barrier 12 is partially or fully integrated within a surrounding structural assembly while still providing the primary mechanical load path between the battery component 10 and the external support structure. The architecture is adaptable to both new installations and retrofit applications and may not require modification to internal electrochemical components of the battery component 10.

In certain embodiments, the mechanical excitation attenuation barrier 12 comprises a support structure 30 configured to receive and support a mechanically compliant mitigating element 28, such as a pad, carrier, or isolator support member. The support structure 30 may comprise a base plate or other load-bearing member positioned between the battery component 10 and an external support structure. The support structure 30 may be rigid, semi-rigid, or otherwise structurally configured to transfer mechanical loads into and through the mechanical excitation attenuation barrier 12 while cooperating with at least one isolator 48 to establish the primary mechanical load path. The support structure 30 may be formed from metals, polymers, composites, hybrid materials, or combinations thereof, and may be manufactured using stamping, molding, casting, machining, additive manufacturing, or other suitable processes.

In one or more embodiments, the at least one isolator 48 is positioned between the battery component 10 and the support structure 30 such that the at least one isolator bears at least a portion of the static and dynamic mechanical loads associated with the battery component 10. The at least one isolator 48 may be configured to support compressive, shear, and/or combined loading conditions while attenuating transmission of mechanical excitation from the support structure 30 to the battery component 10. A retention structure 32, 34 may be configured to capture and retain the mechanically compliant mitigating element 28 and the at least one isolator 48 relative to the support structure 30, thereby limiting unintended lateral displacement, separation, or misalignment during transportation, installation, operation, servicing, relocation, and/or other lifecycle phases. The retention structure 32, 34 may cooperate with the support structure 30 to maintain alignment of the at least one isolator 48 within the primary mechanical load path while permitting controlled mechanical compliance under load.

Base-plate-supported embodiments may be advantageous for retrofit installations, modular energy storage systems, and/or applications in which the mechanical excitation attenuation barrier is configured to be installed without modification to internal electrochemical components or the enclosure of the battery component 10. Such embodiments may facilitate standardized integration across multiple battery sizes, chemistries, and form factors while preserving the architectural principle that attenuation of mechanical excitation occurs within the primary mechanical load path between the battery component 10 and the external support structure. In certain implementations, the base plate 30 may further provide structural rigidity, mounting interfaces, alignment features, and/or environmental protection while cooperating with the at least one isolator 48 and retention structure 32, 34 to maintain controlled mechanical compliance.

In other embodiments, the mechanical excitation attenuation barrier 12 does not include a separate base plate 30. Instead, the support structure may be defined by an existing structural element including, but not limited to, a vehicle frame member, battery tray, rack shelf, enclosure wall, chassis structure, mounting bracket, or other supporting surface. In such embodiments, a mechanically compliant mitigating element 28 may be positioned directly between the battery component 10 and the existing structural element so that attenuation of mechanical excitation occurs within the primary mechanical load path. A retention structure 32, 34 may constrain the mechanically compliant mitigating element 28 relative to the support structure to limit displacement, separation, and/or misalignment during transportation, installation, operation, servicing, relocation, or other lifecycle phases. The retention structure 32, 34 may be integrally formed with the support structure or may be provided as a discrete component. Embodiments without a separate base plate may reduce part count, mass, packaging volume, and/or material usage while maintaining load-bearing capability and consistent attenuation of mechanical excitation.

In certain embodiments, the mechanical excitation attenuation barrier 12 is integrated into a housing or shell of the battery component 10. A mechanically compliant mitigating element 28 may be molded into, bonded to, over-molded with, co-formed with, or otherwise incorporated within the housing structure. For example, a mechanically compliant mitigating element 28 may be formed as an integral portion of a lower housing wall, flange, perimeter feature, or structural interface of a battery enclosure. In such embodiments, the mechanically compliant mitigating element 28 may directly contact an external support structure and serve as at least a portion of the primary mechanical load path while attenuating transmission of mechanical excitation. Integration of the mechanical excitation attenuation barrier 12 into the housing structure may reduce assembly steps, improve alignment consistency, and enable predictable mechanical performance across manufacturing volumes.

Integrated housing embodiments may be advantageous for high-volume manufacturing environments, as they may reduce part count, minimize assembly operations, and promote consistent positioning of the mechanically compliant mitigating element 28 relative to the battery component 10. By incorporating the mechanical excitation attenuation barrier 12 into the housing structure, manufacturing variability may be reduced and alignment of the primary mechanical load path may be controlled with greater precision. Such embodiments may also improve packaging efficiency and structural integration within larger system architectures.

In certain embodiments, the mechanical excitation attenuation barrier 12 may be configured as a monolithic component in which the mechanically compliant mitigating element 28, the support structure, and the retention structure are integrally formed as a single piece. Such monolithic embodiments may be manufactured using processes including, but not limited to, molding, casting, additive manufacturing, over-molding, machining, or combinations thereof. Integrally formed configurations may reduce assembly complexity, improve alignment consistency, and minimize potential rigid bypass paths within the primary mechanical load path.

In other embodiments, the mechanical excitation attenuation barrier 12 is modular and comprises multiple components assembled together. Modular embodiments may permit the mechanically compliant mitigating element 28 and/or the at least one isolator 48 to be replaced, reconfigured, or tuned independently of the support structure or retention structure. Such modular configurations may facilitate servicing, lifecycle adaptation, application-specific customization, and performance tuning without requiring redesign of the battery, battery module, or battery assembly. Both monolithic and modular embodiments are contemplated and may be selected based on manufacturing considerations, serviceability requirements, cost objectives, and/or performance criteria.

In certain embodiments, the mechanical excitation attenuation barrier 12 is externally visible when installed relative to the battery, battery module, or battery assembly. External visibility may provide a visual indication of the presence of mechanical excitation attenuation and may facilitate identification, inspection, servicing, branding, and/or verification of proper installation. In other embodiments, the mechanical excitation attenuation barrier 12 is partially or fully concealed within a housing, vehicle structure, rack, tray, enclosure, or other installation structure. Concealed embodiments may be preferred where environmental protection, packaging constraints, or aesthetic considerations are prioritized. The visibility or concealment of the mechanical excitation attenuation barrier 12 does not affect its function as a primary mechanical load path or its ability to attenuate mechanical excitation.

Retention structures 32, 34 may take a variety of forms depending on the embodiment and installation requirements. For example, a retention structure may include, but is not limited to, clips, clamps, frames, lips, fasteners, over-molded features, interference fits, adhesives, straps, brackets, capture plates, or combinations thereof. The retention structure may be configured to constrain the mechanically compliant mitigating element 28 and/or at least one isolator 48 relative to a support structure while preserving the primary mechanical load path through the mechanical excitation attenuation barrier 12.

In some embodiments, the retention structure 32, 34 constrains the mechanically compliant mitigating element 28 and/or at least one isolator 48 primarily in lateral directions while permitting vertical compression and controlled deformation under load. In other embodiments, the retention structure constrains motion in multiple directions, including vertical, lateral, longitudinal, and/or rotational directions, depending on system requirements. Retention structures may be configured for permanent installation or for removal, replacement, adjustment, and/or reconfiguration of the mechanically compliant mitigating element 28 and/or at least one isolator 48, such as during servicing, tuning, or lifecycle transitions.

The mechanically compliant mitigating element 28 and/or the mechanical excitation attenuation barrier 12 may include at least one isolator 48 or a plurality of isolators arranged in various configurations. The isolator or isolators may be arranged symmetrically, asymmetrically, centrally, peripherally, and/or in distributed patterns to accommodate uniform or uneven load distributions. In certain embodiments, the isolator or isolators are positioned at corners, edges, perimeter regions, central regions, and/or intermediate regions of the battery, battery module, or battery assembly. In other embodiments, the isolator or isolators are distributed across a surface or provided as a continuous layer, segmented layer, or composite structure. The quantity, geometry, material composition, and/or spatial arrangement of the at least one isolator may be selected, adjusted, and/or tuned to achieve a desired load distribution, stiffness profile, directional compliance, damping behavior, and/or mechanical excitation attenuation performance within the primary mechanical load path.

The at least one isolator 48 may be formed from elastomeric, polymeric, rubber, polyurethane, thermoplastic polyurethane, silicone-based materials, composite materials, and/or other mechanically compliant materials suitable for passive mechanical excitation attenuation. Material selection may consider properties including, but not limited to, stiffness, damping characteristics, durometer, temperature stability, thermal expansion behavior, chemical resistance, fatigue resistance, creep resistance, compression set, environmental durability, and/or long-term aging performance. In certain embodiments, the at least one isolator is formed from a single material. In other embodiments, the at least one isolator comprises multiple materials arranged in layers, gradients, regions, inserts, composite structures, or other multi-material configurations to achieve desired mechanical performance characteristics within the primary mechanical load path.

Support structures and retention structures associated with the mechanical excitation attenuation barrier may be manufactured using a variety of processes, including stamping, molding, casting, machining, additive manufacturing, extrusion, forming, bonding, or combinations thereof. Selection of a particular manufacturing process may depend on factors such as cost, production volume, material selection, dimensional tolerances, structural performance requirements, integration constraints, serviceability considerations, and/or environmental exposure. In certain embodiments, support and retention structures may be co-manufactured with other structural components of a vehicle, rack, enclosure, tray, or mounting system to reduce part count and assembly complexity while preserving the primary mechanical load path through the mechanical excitation attenuation barrier.

The at least one isolator may be configured in a variety of geometries and may be formed from one or more materials depending on application requirements, load conditions, and/or desired mechanical excitation attenuation characteristics. The at least one isolator may function as a load-bearing structural element and/or as a mechanically compliant element within the primary mechanical load path between the battery, battery module, or battery assembly and an external support structure. In certain embodiments, the at least one isolator may be configured to deform elastically, viscoelastically, or otherwise in response to mechanical excitation while maintaining structural support of the battery, battery module, or battery assembly. Such deformation characteristics may be selected, tuned, and/or controlled to achieve desired attenuation performance across one or more excitation modes, directions, amplitudes, and/or frequency ranges encountered during transportation, installation, operation, servicing, relocation, and/or other lifecycle phases.

The at least one isolator may be formed in a variety of geometrical shapes, including, but not limited to, cylindrical, conical, frustoconical, pyramidal frustum, spherical, hemispherical, planar, stepped, ribbed, webbed, multi-lobed, lattice, cellular, hollow, partially hollow, solid, faceted, tapered, contoured, asymmetric, symmetric, or compound geometries, and/or combinations thereof. Such geometries may be configured to provide selected stiffness, directional compliance, load-bearing capability, deformation behavior, and/or mechanical excitation attenuation characteristics within the primary mechanical load path. In certain embodiments, geometrical features may be configured to provide anisotropic compliance, directional isolation, progressive stiffness response, and/or nonlinear mechanical response under varying load conditions and/or excitation amplitudes.

In certain embodiments, the at least one isolator may comprise an outer ring portion and an inner ring portion connected by one or more mechanically compliant web structures configured to deform under load and attenuate transmission of mechanical excitation. In other embodiments, the at least one isolator may comprise a solid, partially hollow, hollow, lattice, cellular, or otherwise structured body configured to elastically and/or viscoelastically deform under load while maintaining structural support within the primary mechanical load path. The at least one isolator may further include internal cavities, voids, channels, graded density regions, and/or multi-material regions configured to influence stiffness, damping, deformation behavior, and/or mechanical excitation attenuation characteristics. Such configurations may be selected to achieve desired load-bearing capability, directional compliance, attenuation performance, durability, and/or system natural frequency characteristics when supporting the battery, battery module, or battery assembly.

The geometry of the at least one isolator may be selected, combined, and/or modified to achieve desired stiffness characteristics, load-bearing capacity, directional compliance, damping behavior, and/or mechanical excitation attenuation performance within the primary mechanical load path. Geometrical features including, but not limited to, thickness variation, tapering, ribs, webs, voids, cavities, internal structures, facets, contours, and/or graded structural regions may be used individually and/or in combination to influence deformation behavior and mechanical response under static, dynamic, and/or transient loading conditions. In certain embodiments, geometrical features may be configured to produce nonlinear stiffness characteristics, progressive load response, quasi-zero stiffness behavior, and/or frequency-dependent attenuation characteristics. The geometry of the at least one isolator may further be configured to accommodate manufacturing constraints, packaging requirements, installation tolerances, and/or system-level mechanical performance objectives when supporting the battery, battery module, or battery assembly.

Material selection for the at least one isolator may consider properties including, but not limited to, stiffness, damping characteristics, durometer, elastic modulus, viscoelastic behavior, temperature stability, thermal aging resistance, chemical resistance, fatigue resistance, creep resistance, compression set characteristics, environmental durability, and/or long-term mechanical stability. In certain embodiments, the at least one isolator may be formed from a single homogeneous material. In other embodiments, the at least one isolator may comprise multiple materials arranged in layers, regions, gradients, composite structures, and/or hybrid configurations to achieve desired mechanical response characteristics and/or mechanical excitation attenuation performance. Material selection may be coordinated with isolator geometry, system mass, load distribution, and/or installation configuration to achieve targeted natural frequency characteristics and/or attenuation performance within the primary mechanical load path supporting the battery, battery module, or battery assembly.

In one or more embodiments, the at least one isolator may be selected, configured, manufactured, and/or installed with a specified durometer, stiffness, damping characteristic, and/or other mechanical property to achieve desired load-bearing capability and/or mechanical excitation attenuation performance. In certain embodiments, multiple isolators within a single mechanical excitation attenuation barrier may possess differing durometers, stiffness values, geometries, materials, and/or structural configurations to provide spatially varying compliance, load distribution, and/or attenuation performance. Such variation may be used to tune natural frequency characteristics, control load transfer behavior, accommodate asymmetric mass distribution, compensate for installation conditions, and/or optimize attenuation of mechanical excitation within the primary mechanical load path supporting the battery, battery module, or battery assembly. Selection and arrangement of isolator properties may be performed during design, manufacturing, installation, replacement, and/or reconfiguration phases to achieve desired system-level mechanical response characteristics.

Durometer selection of the at least one isolator may influence load-bearing capability, effective stiffness, damping behavior, and/or frequency response of the at least one isolator under static and/or dynamic loading conditions. In some embodiments, the at least one isolator is configured to operate within a selected portion of a load–deflection curve to achieve predictable mechanical response characteristics and/or controlled attenuation of mechanical excitation.

Durometer variation may be used to tune natural frequency, load distribution, and/or attenuation performance of the combined system formed by the mechanical excitation attenuation barrier and the battery, battery module, or battery assembly, either alone or in combination with changes in isolator geometry, internal structure, spatial arrangement, material composition, and/or preload characteristics.

The at least one isolator may be solid, partially hollow, or include internal voids and/or structured features. Hollow and/or structured isolators may provide increased compliance, reduced mass, and/or controlled stiffness while maintaining load-bearing capability. Internal structures including, but not limited to, cavities, channels, lattices, cellular features, and/or engineered internal geometries may be used to tailor mechanical response, attenuation performance, load distribution, and/or natural frequency characteristics.

In some embodiments, the at least one isolator is configured to provide anisotropic compliance, exhibiting different stiffness and/or damping characteristics along different axes. Directional compliance may be achieved through isolator geometry, material selection, internal structure, and/or spatial arrangement. Such embodiments may provide increased attenuation of mechanical excitation along one axis while maintaining increased stiffness along one or more other axes to support stability, alignment, and/or structural integrity of the battery, battery module, or battery assembly.

The at least one isolator may be manufactured using a variety of processes suitable for forming mechanically compliant elements, including, but not limited to, molding, casting, extrusion, machining, additive manufacturing, over-molding, compression molding, injection molding, transfer molding, and/or combinations thereof. Manufacturing processes may be selected based on factors including, but not limited to, material properties, geometry, dimensional tolerances, surface characteristics, durability requirements, production volume, cost considerations, and/or integration requirements.

In some embodiments, the at least one isolator is over-molded onto, bonded to, integrally formed with, and/or otherwise mechanically coupled to one or more support structures, retention structures, and/or interface features. In other embodiments, the at least one isolator is manufactured as a separate component and assembled during manufacturing, installation, servicing, replacement, and/or reconfiguration of the mechanical excitation attenuation barrier.

Manufacturing processes may also be selected or adapted to enable formation of internal isolator structures including, but not limited to, voids, cavities, channels, lattices, gradients in material properties, multi-material constructions, surface textures, and/or engineered structural features configured to influence stiffness, damping behavior, preload characteristics, load distribution, attenuation performance, and/or long-term mechanical stability.

The at least one isolator may be configured to interface with one or more retention structures, including, but not limited to, clips, clamps, frames, lips, fasteners, over-molded features, interference fits, adhesives, and/or combinations thereof. The interface between the at least one isolator and the retention structure may be configured to prevent unintended displacement, separation, and/or misalignment while permitting controlled deformation of the at least one isolator under mechanical loading.

Retention structures may be configured to constrain motion of the at least one isolator along one or more axes while permitting compliant deformation along one or more other axes. Such configurations may be selected to preserve the primary mechanical load path through the at least one isolator while enabling attenuation of mechanical excitation transmitted between an external support structure and the battery, battery module, or battery assembly.

Retention structures may also contribute to defining load transfer characteristics, preload conditions, positional alignment, and/or deformation behavior of the at least one isolator relative to the support structure and the battery, battery module, or battery assembly. In some embodiments, the retention structure is configured to maintain the at least one isolator in a desired position and/or preload state to preserve the primary mechanical load path through the mechanical excitation attenuation barrier while permitting controlled compliant deformation during transmission of mechanical excitation.

In one or more embodiments, configuration of the mechanical excitation attenuation barrier includes selecting and/or arranging at least one isolator to support a battery, battery module, or battery assembly while attenuating transmission of mechanical excitation through a primary mechanical load path. Configuration objectives may include, but are not limited to: supporting static and/or dynamic loads associated with the battery, battery module, or battery assembly; attenuating mechanical excitation within one or more target frequency ranges; achieving, targeting, or maintaining a desired system natural frequency, including, but not limited to, a natural frequency of 200 Hz or less; maintaining positional stability and/or alignment under multi-axis loading conditions; and/or satisfying packaging, durability, environmental, and/or integration constraints.

Configuration of the mechanical excitation attenuation barrier may be performed during design, manufacturing, assembly, installation, transportation, servicing, relocation, replacement, reconfiguration, and/or operation of the battery, battery module, or battery assembly. In some embodiments, configuration includes selecting, modifying, replacing, repositioning, or otherwise adjusting at least one isolator, support structure, retention structure, and/or interface feature to achieve, maintain, or adapt attenuation performance and load-bearing capability across one or more lifecycle phases and/or deployment environments.

In one or more embodiments, configuration includes selecting characteristics of the at least one isolator based on anticipated operating conditions, environmental conditions, load conditions, packaging constraints, and/or performance objectives associated with the battery, battery module, or battery assembly. Isolator characteristics may include, but are not limited to, stiffness, damping behavior, durometer, geometry, material composition, mass distribution, internal structure, dimensional properties, load-bearing capacity, preload characteristics, spatial arrangement, and/or interface characteristics. Selection and/or adjustment of such characteristics may influence attenuation performance, load transfer behavior, natural frequency, durability, and/or system stability of the combined system formed by the mechanical excitation attenuation barrier and the supported battery, battery module, or battery assembly.

In one or more embodiments, the at least one isolator is selected, configured, and/or positioned to exhibit linear stiffness behavior, non-linear stiffness behavior, progressive stiffness behavior, and/or variable stiffness behavior over one or more portions of its operating range. In certain embodiments, the at least one isolator exhibits quasi-zero stiffness behavior, negative stiffness behavior, or reduced effective stiffness over a portion of its load–deflection response to enhance attenuation of mechanical excitation while maintaining load-bearing capability. Such stiffness characteristics may be achieved through selection of geometry, material composition, internal structure, spatial arrangement, preload conditions, and/or interaction with support and retention structures. These configurations may enable improved attenuation of mechanical excitation, control of system natural frequency, and/or predictable mechanical response under static, dynamic, transient, and/or multi-axis loading conditions.

Material selection for the at least one isolator may consider properties including, but not limited to, temperature stability, chemical resistance, fatigue resistance, creep resistance, compression set resistance, environmental durability, and/or long-term aging behavior under sustained static, dynamic, and/or cyclic mechanical loading conditions. In some embodiments, material selection may be configured to maintain consistent mechanical excitation attenuation performance across variations in temperature, humidity, vibration exposure, mechanical shock exposure, and/or environmental operating conditions. Material selection may also be configured to preserve stiffness characteristics, damping behavior, structural integrity, and/or load-bearing capability throughout transportation, installation, operation, servicing, relocation, and/or other lifecycle phases of the supported battery, battery module, and/or battery assembly.

Configuration of the mechanical excitation attenuation barrier may include selecting a quantity and/or spatial arrangement of the at least one isolator relative to the battery, battery module, and/or battery assembly. The at least one isolator may be arranged symmetrically, asymmetrically, peripherally, centrally, distributed across a surface, and/or in any other arrangement configured to support static and/or dynamic loads while attenuating transmission of mechanical excitation. The spatial arrangement of the at least one isolator may be configured to accommodate uneven load distributions, center-of-mass offsets, packaging constraints, and/or structural interface characteristics. In some embodiments, configuration of isolator quantity and/or spatial arrangement may be used to tune stiffness, load transfer behavior, natural frequency, and/or mechanical excitation attenuation performance of the passive isolation system formed by the mechanical excitation attenuation barrier and the battery, battery module, and/or battery assembly.

In one or more embodiments, configuration of the mechanical excitation attenuation barrier includes defining and/or maintaining a primary mechanical load path between the battery, battery module, and/or battery assembly and an external support structure. The primary mechanical load path is established such that mechanical loads acting on the battery, battery module, and/or battery assembly are transmitted predominantly through the mechanical excitation attenuation barrier and its at least one mechanically compliant element. In this manner, attenuation of mechanical excitation occurs within the primary mechanical load path itself, rather than through incidental or secondary structural features. Establishment and/or maintenance of the primary mechanical load path enables predictable and tunable attenuation of mechanical excitation while providing structural support and positional stability of the battery, battery module, and/or battery assembly.

Definition and/or maintenance of the primary mechanical load path may include configuring support structures, retention structures, interface features, and/or spatial positioning of the at least one mechanically compliant element to prevent or reduce rigid mechanical bypass paths that would otherwise transmit mechanical excitation directly between the external support structure and the battery, battery module, and/or battery assembly. By controlling the primary mechanical load path, attenuation of mechanical excitation occurs at the structural interface through which mechanical loads are predominantly transmitted. In one or more embodiments, configuration may further include tuning mechanical properties of the mechanical excitation attenuation barrier and/or the at least one isolator, including, but not limited to, stiffness, damping behavior, geometry, material composition, preload, and/or spatial arrangement, to achieve desired attenuation performance and/or natural frequency characteristics of the combined system.

Tuning of the mechanical excitation attenuation barrier and/or the at least one isolator may be achieved by adjusting one or more characteristics including, but not limited to, stiffness, durometer, damping behavior, geometry, material composition, preload, mass distribution, spatial arrangement, and/or interface configuration. Such tuning may position one or more natural frequencies of the combined system formed by the mechanical excitation attenuation barrier and the battery, battery module, and/or battery assembly at or below a selected threshold, including, but not limited to, approximately 200 Hz or less, and/or within frequency ranges associated with transportation, installation, operation, servicing, relocation, environmental exposure, and/or other lifecycle phases. In one or more embodiments, tuning may reduce amplification of mechanical excitation near resonant frequencies and/or improve attenuation performance across one or more frequency ranges of interest.

In one or more embodiments, configuration and/or tuning of the mechanical excitation attenuation barrier includes defining directional compliance characteristics of the at least one isolator such that stiffness, damping behavior, and/or attenuation performance differ along one or more axes. Directional compliance may be achieved through selection of geometry, material composition, internal structure, preload conditions, spatial arrangement, interface configuration, and/or combinations thereof. Such directional tuning may allow the mechanical excitation attenuation barrier to attenuate mechanical excitation along one or more selected axes while maintaining sufficient stiffness along other axes to preserve structural support, positional stability, alignment, and/or load-bearing capability of the battery, battery module, and/or battery assembly.

For example, the mechanical excitation attenuation barrier may be configured to provide increased mechanical compliance in a vertical direction while maintaining increased stiffness in lateral, longitudinal, rotational, and/or other directions to preserve positional stability, alignment, and structural support of the battery, battery module, and/or battery assembly. Multi-axis tuning enables attenuation of mechanical excitation resulting from complex loading conditions, including, but not limited to, combined translational, rotational, impulse, transient, sustained, and/or broadband excitation.

Configuration and/or tuning of the mechanical excitation attenuation barrier may be performed at various stages of a system lifecycle. In some embodiments, configuration and/or tuning is performed during design and/or manufacturing using analytical modeling, simulation, empirical testing, and/or combinations thereof. In other embodiments, configuration and/or tuning is performed during installation, servicing, replacement, and/or reconfiguration by selecting, modifying, and/or positioning at least one isolator, shim, spacer, retention structure, and/or support structure appropriate for a specific application, operating environment, and/or system requirement.

Shims, spacers, interface elements, and/or other adjustment structures may be used in conjunction with the mechanical excitation attenuation barrier to adjust preload applied to the at least one isolator, compensate for dimensional tolerances, control alignment, and/or tune effective stiffness, damping behavior, load distribution, and/or natural frequency of the passive isolation system formed by the mechanical excitation attenuation barrier and the battery, battery module, and/or battery assembly. Such adjustment structures may be positioned between the at least one isolator and a support structure, retention structure, battery enclosure, and/or other interfacing component to enable controlled configuration and/or tuning of mechanical excitation attenuation characteristics.

In some embodiments, configuration and/or tuning of the mechanical excitation attenuation barrier may be performed after initial installation by replacing, repositioning, modifying, and/or reconfiguring the at least one isolator, shim, spacer, retention structure, support structure, and/or other mechanically compliant mitigating element to accommodate changes in operating conditions, system configuration, deployment environment, mounting orientation, load distribution, and/or system requirements. Such post-installation configurability enables continued attenuation of mechanical excitation while preserving the primary mechanical load path through the mechanical excitation attenuation barrier.

The configuration and tuning methods described herein are directed to passive mechanical systems in which attenuation of mechanical excitation is achieved without reliance on active control systems, sensors, actuators, powered feedback mechanisms, and/or external energy sources. Instead, attenuation of mechanical excitation is achieved through mechanical properties, geometry, material selection, spatial arrangement, and/or structural configuration of the mechanical excitation attenuation barrier and the at least one isolator positioned within the primary mechanical load path. This passive architecture may reduce system complexity, cost, power consumption, packaging requirements, and/or potential failure modes while providing consistent attenuation of mechanical excitation across a wide range of operating conditions, environments, and lifecycle phases.

The configuration and tuning methods described herein are applicable to a wide range of systems and deployment environments, including, but not limited to, electric vehicles, hybrid vehicles, autonomous systems, robotics platforms, stationary energy storage systems, industrial equipment, transportation platforms, mobile systems, and/or other installations in which a battery, battery module, and/or battery assembly is exposed to mechanical excitation. The mechanical excitation attenuation barrier may be configured to support batteries of varying chemistries, sizes, masses, geometries, and/or form factors while preserving attenuation of mechanical excitation through the primary mechanical load path.

The configuration principles described herein may be applied to batteries, battery modules, and/or battery assemblies having different electrochemical chemistries, internal architectures, form factors, masses, geometries, mounting configurations, and/or operating environments. The mechanical excitation attenuation barrier may be configured to support and isolate such batteries while preserving attenuation of mechanical excitation through the primary mechanical load path, regardless of internal battery construction, electrochemical design, or packaging configuration.

In one or more embodiments, the mechanical excitation attenuation barrier is employed to support a battery, battery module, and/or battery assembly within a vehicle or mobile platform. The mechanical excitation attenuation barrier may be positioned between the battery and a vehicle structure, including, but not limited to, a chassis member, frame rail, crossmember, mounting bracket, tray, enclosure, structural platform, and/or other supporting structure. In such embodiments, mechanical excitation transmitted from the vehicle structure to the battery during operation may be attenuated through the mechanical excitation attenuation barrier while maintaining structural support and positional stability of the battery.

During operation of a vehicle or mobile system, mechanical excitation acting on the battery may result from acceleration, braking, cornering, vibration, impacts, road irregularities, structural flexing, environmental conditions, and/or operational loads. The mechanical excitation attenuation barrier attenuates transmission of such mechanical excitation to the battery while maintaining the primary mechanical load path and supporting static, dynamic, and/or combined mechanical loads acting on the battery, battery module, and/or battery assembly.

In certain embodiments, the mechanical excitation attenuation barrier supports a battery, battery module, and/or battery assembly within hybrid vehicles, electric vehicles, autonomous vehicles, industrial vehicles, robotics systems, transportation equipment, and/or other mechanically dynamic platforms. Such systems may expose the battery to mechanical excitation originating from propulsion systems, structural interfaces, drivetrain components, operational motion, environmental conditions, and/or external forces. The mechanical excitation attenuation barrier may be configured to attenuate mechanical excitation across one or more frequency ranges while preserving the primary mechanical load path between the battery and the supporting structure.

In some embodiments, the mechanical excitation attenuation barrier is employed to support a battery, battery module, and/or battery assembly within stationary energy storage installations, including, but not limited to, grid-connected energy storage systems, backup power systems, microgrids, energy storage containers, equipment enclosures, and/or structural installations. In such embodiments, the battery, battery module, and/or battery assembly may be supported within racks, cabinets, frames, shelves, platforms, or other support structures. The mechanical excitation attenuation barrier may attenuate mechanical excitation arising from transportation, installation, seismic activity, nearby machinery, thermal expansion, structural movement, and/or environmental conditions while maintaining structural support and preservation of the primary mechanical load path.

In certain embodiments, the mechanical excitation attenuation barrier supports a battery, battery module, and/or battery assembly during transportation, shipping, handling, staging, and/or deployment operations. Such embodiments may include over-the-road transport, rail transport, marine transport, air transport, warehouse handling, installation staging, and/or relocation activities. The mechanical excitation attenuation barrier may attenuate mechanical excitation resulting from impacts, drops, vibration, stacking loads, and/or handling forces while maintaining structural support and preserving the primary mechanical load path.

The mechanical excitation attenuation barrier may be configured to attenuate mechanical excitation resulting from handling impacts, transient forces, sustained vibration, stacking loads, and/or transportation-induced excitation while maintaining the battery in a supported condition through the primary mechanical load path. The mechanical excitation attenuation barrier may provide consistent attenuation performance across multiple lifecycle phases, including manufacturing, transport, installation, operation, servicing, relocation, and/or redeployment.

In some embodiments, the mechanical excitation attenuation barrier is employed to support a battery, battery module, and/or battery assembly in industrial equipment, including, but not limited to, robotics systems, automated machinery, material-handling equipment, construction equipment, agricultural equipment, mining equipment, mobile power systems, and/or other mechanically dynamic systems. Such systems may generate mechanical excitation during operation, motion, or interaction with external environments. The mechanical excitation attenuation barrier may attenuate transmission of such mechanical excitation to the battery, battery module, and/or battery assembly while preserving the primary mechanical load path and maintaining positional stability.

In certain embodiments, one or more mechanical excitation attenuation barriers are employed in modular energy storage systems in which multiple batteries, battery modules, and/or battery assemblies are combined to form larger systems. Each battery, battery module, and/or battery assembly may be supported by a corresponding mechanical excitation attenuation barrier. In these embodiments, the mechanical excitation attenuation barriers may be configured to accommodate variations in load, alignment, thermal expansion, mass distribution, and/or structural interface conditions between individual batteries, battery modules, and/or battery assemblies while attenuating mechanical excitation at the individual unit level, the module level, the assembly level, the system level, and/or combinations thereof.

In some embodiments, the mechanical excitation attenuation barrier is installed as part of a retrofit or aftermarket modification to an existing energy storage system. The mechanical excitation attenuation barrier may be added without modification of internal electrochemical components of a battery, battery module, and/or battery assembly. Retrofit embodiments may utilize standalone mechanical excitation attenuation barriers, adapter structures, interface structures, replacement mounting interfaces, and/or combinations thereof to introduce attenuation of mechanical excitation while preserving existing electrical interfaces, thermal interfaces, structural interfaces, and/or system functionality.

In certain embodiments, the mechanical excitation attenuation barrier supports a battery, battery module, and/or battery assembly in harsh or specialized environments, including, but not limited to, off-road vehicles, marine environments, aerospace platforms, defense systems, robotics platforms, industrial platforms, portable power systems, and/or remote installations. In such embodiments and other embodiments, the mechanical excitation attenuation barrier may be configured to accommodate environmental factors including, but not limited to, temperature extremes, thermal cycling, moisture exposure, chemical exposure, corrosion exposure, dust exposure, debris exposure, pressure variations, sustained mechanical excitation, transient mechanical excitation, and/or combinations thereof while maintaining attenuation of mechanical excitation and structural support.

Features described in connection with one embodiment may be combined with features of other embodiments. For example, a battery, battery module, and/or battery assembly may experience transportation, installation, storage, operational use, servicing, relocation, and/or redeployment during its lifecycle. Accordingly, the mechanical excitation attenuation barrier may be configured to support the battery, battery module, and/or battery assembly across multiple lifecycle phases and use-case scenarios while preserving the primary mechanical load path and attenuation of mechanical excitation.

In one or more embodiments, the mechanical excitation attenuation barrier attenuates transmission of mechanical excitation from an external support structure to a battery, battery module, and/or battery assembly across one or more frequency ranges, which may vary based on isolator geometry, material selection, durometer, preload conditions, spatial arrangement, and/or supported system mass. Attenuation performance may be characterized using metrics including, but not limited to, transmissibility, acceleration reduction, displacement reduction, force attenuation, energy dissipation, damping ratio, and/or other mechanical response metrics. Such metrics may be evaluated under steady-state excitation, transient excitation, impulse excitation, broadband excitation, and/or combinations thereof.

In some embodiments, the mechanical excitation attenuation barrier provides a primary mechanical load path between a battery, battery module, and/or battery assembly and an external support structure. Static loads, dynamic loads, impulse loads, sustained loads, transient loads, and/or combinations thereof may be transmitted through the mechanical excitation attenuation barrier while maintaining structural integrity and attenuating transmission of mechanical excitation to the battery, battery module, and/or battery assembly.

The mechanical excitation attenuation barrier may be configured to support gravitational loads, inertial loads, operational loads, and/or combinations thereof, including, but not limited to, loads resulting from acceleration, deceleration, braking, cornering, impact events, transient mechanical excitation, sustained mechanical excitation, thermal expansion, installation, servicing, transportation, and/or environmental exposure.

In certain embodiments, the combined system formed by the mechanical excitation attenuation barrier and the battery, battery module, and/or battery assembly exhibits a natural frequency selected, achieved, targeted, and/or maintained to reduce transmissibility within one or more target frequency ranges. Such tuning may be achieved through selection, arrangement, and/or configuration of at least one isolator, including modification of isolator geometry, material selection, durometer, preload, spatial arrangement, supported system mass distribution, and/or combinations thereof.

In some embodiments, the mechanical excitation attenuation barrier maintains attenuation performance across a range of environmental conditions, including, but not limited to, temperature extremes, thermal cycling, humidity, moisture exposure, chemical exposure, dust exposure, debris exposure, vibration exposure, shock exposure, and/or prolonged mechanical loading.

Attenuation performance and load-bearing capability may be maintained over repeated loading cycles, extended service life, and/or lifecycle phases including, but not limited to, transportation, installation, storage, normal operation, servicing, relocation, redeployment, and/or decommissioning.

In one representative example, a battery component, including a battery module, is supported within a vehicle structure by a mechanical excitation attenuation barrier positioned between the battery component and a chassis-mounted support. During vehicle operation, road-induced vibration and/or transient shock events are transmitted through the mechanical excitation attenuation barrier as part of the primary mechanical load path.

The mechanical excitation attenuation barrier attenuates transmission of mechanical excitation to the battery component while maintaining positional stability and structural support. Performance characteristics may vary depending on isolator configuration, system configuration, and/or operating conditions.

In another representative example, a battery component, including a battery assembly, is supported within a stationary energy storage enclosure using a mechanical excitation attenuation barrier. The mechanical excitation attenuation barrier attenuates mechanical excitation resulting from transportation, installation, seismic activity, nearby machinery, and/or thermal expansion while maintaining structural support and alignment.

The mechanical excitation attenuation barrier may be configured differently for transportation conditions, installation conditions, and/or operational conditions through design selection, isolator selection, adjustable features, and/or modular configuration.

In some embodiments, multiple mechanical excitation attenuation barrier configurations may be employed within a single system. For example, isolators of different geometries, materials, stiffness characteristics, and/or spatial arrangements may be used at different locations to achieve spatially varying attenuation performance and/or load-bearing characteristics.

Alternative performance configurations may include trade-offs between attenuation performance, stiffness, load capacity, durability, packaging volume, cost, and/or system integration considerations. Such trade-offs may be selected based on system-level requirements and/or performance objectives.

The performance descriptions and examples provided herein are illustrative and non-limiting. No particular performance level, frequency range, configuration, test protocol, or outcome is required unless expressly recited in the claims. Features described in connection with one embodiment may be combined with features of other embodiments unless expressly stated otherwise.

Interfaces between the mechanical excitation attenuation barrier and adjacent structures may be configured to allow relative motion along selected axes while constraining motion along other axes, thereby preserving the primary mechanical load path and enabling attenuation of mechanical excitation.

In some embodiments, the primary mechanical load path passes substantially through at least one isolator. In other embodiments, the primary mechanical load path may be shared between at least one isolator and additional structural elements configured to control preload, limit displacement, provide alignment, and/or provide secondary support while preserving attenuation of mechanical excitation.

Constraint mechanisms may include, but are not limited to, hard stops, compliant stops, limiters, shims, spacers, sacrificial elements, interface features, and/or combinations thereof configured to engage under selected loading conditions.

The mechanical excitation attenuation barrier may be used in a wide range of applications, including, but not limited to, electric vehicles, hybrid vehicles, stationary energy storage systems, robotics systems, industrial equipment, transportation platforms, aerospace platforms, marine systems, portable power systems, and/or consumer products.

Specific embodiments of the battery component 10 and mechanical excitation attenuation barrier 12 are described with reference to the accompanying drawings. These embodiments are illustrative and non-limiting, and variations, modifications, and alternative configurations are contemplated.

The battery component 10 may comprise a battery, battery module, and/or battery assembly of any electrochemical type, including, but not limited to, lithium-ion batteries, lead-acid batteries, absorbent glass mat batteries, solid-state batteries, sodium-ion batteries, and/or other electrochemical energy storage devices. The battery component may include a housing or enclosure 14 configured to contain electrochemical components, electrical interfaces, and/or structural components.

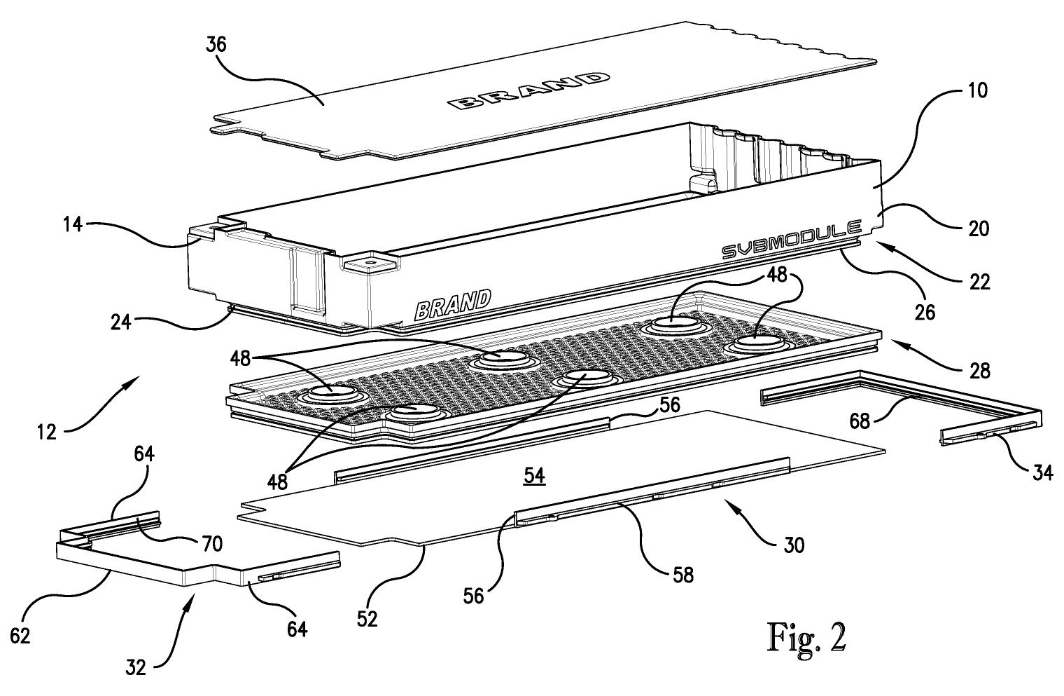

In certain embodiments, the battery component 10 may include structural features configured to interface with a mechanical excitation attenuation barrier 12. As illustrated in FIG. 2, the battery component 10 may include lower wall portions defining an upper section 20 and a lower section 22 of reduced lateral dimensions relative to the upper section. This configuration may define a circumscribing channel 24 positioned along a lower region of the battery component 10. In some embodiments, the channel 24 may be bounded at least in part by a retaining flange 26 or similar structural feature configured to interface with a mechanically compliant mitigating element, including but not limited to a mechanical excitation attenuation barrier, pad, isolator structure, or combinations thereof. The channel 24 may provide a receiving region configured to accommodate at least a portion of the mechanical excitation attenuation barrier 12, enabling positioning of the barrier relative to the battery component 10 while preserving overall packaging compatibility. In certain embodiments, incorporation of such structural features may result in a reduction of internal volumetric capacity of less than approximately 25%, less than approximately 10%, less than approximately 5%, or other suitable amounts depending on system requirements, packaging constraints, and performance objectives. In other embodiments, the battery component may omit such channel features entirely, and the mechanical excitation attenuation barrier may instead be positioned externally relative to the battery enclosure, integrated into surrounding support structures, or otherwise configured to provide a primary mechanical load path while attenuating mechanical excitation.

In certain embodiments, components of the mechanical excitation attenuation barrier 12 may be positioned at least partially within the channel 24 of the battery component 10, when such channel features are present. As illustrated in FIG. 2, an example embodiment of the mechanical excitation attenuation barrier 12 may include a mechanically compliant mitigating element 28, a support structure 30, one or more retention structures 32, 34, and optionally a cover or interface structure 36. These components may cooperate to provide structural support for the battery component 10 while attenuating transmission of mechanical excitation through a primary mechanical load path. In other embodiments, the mechanical excitation attenuation barrier may be positioned externally relative to the battery enclosure or integrated into adjacent support structures.

In certain embodiments, the mechanically compliant mitigating element 28 may be positioned between the battery component 10 and the support structure 30 such that mechanical loads transmitted between the battery component and an external support structure pass through the mitigating element. The support structure 30 may be configured for attachment to or integration with a vehicle structure, battery rack, enclosure, or other external support structure. Retention structures 32, 34 may secure, capture, constrain, or position the mechanically compliant mitigating element 28 relative to the support structure 30 and/or battery component 10. An optional cover or interface structure 36 may provide protective, structural, identification, or functional features without interfering with attenuation of mechanical excitation.

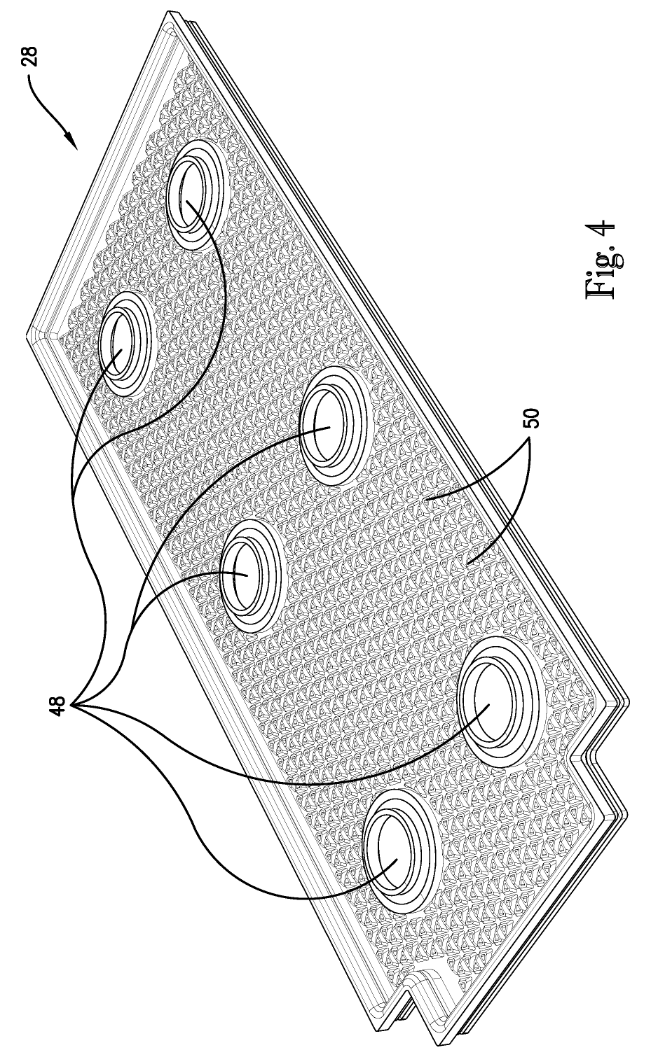

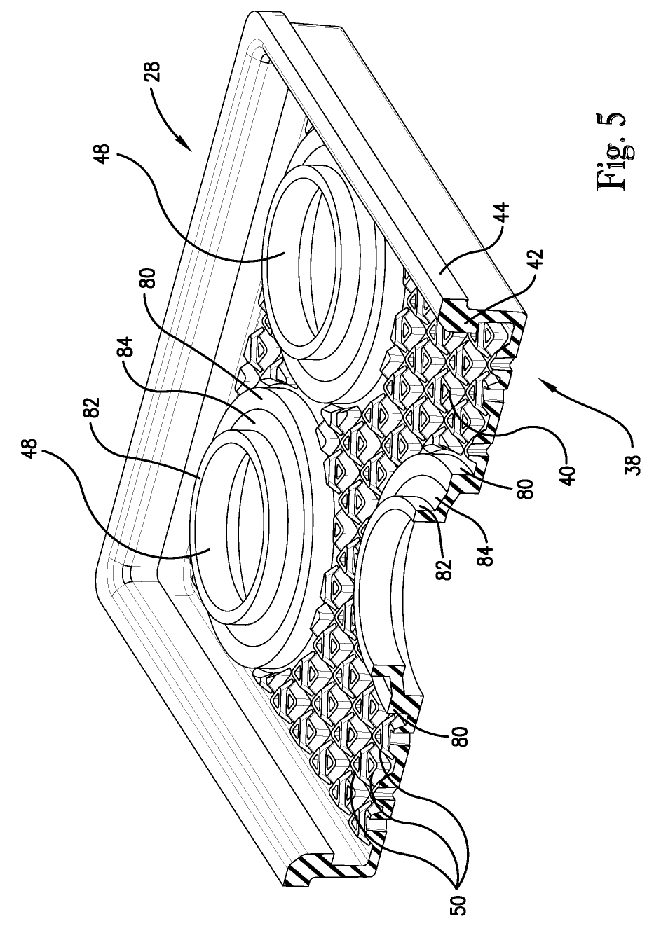

In certain embodiments, as illustrated for example in FIGS. 4 and 5, the mechanically compliant mitigating element 28 may be formed from one or more mechanically compliant materials, including, but not limited to, elastomers, polymeric materials, thermoplastic polyurethane, polyurethane, rubber, composite materials, or combinations thereof. Material properties may be selected to provide desired stiffness, damping behavior, durability, environmental resistance, and/or attenuation performance. The mechanically compliant mitigating element 28 may be formed using manufacturing processes including, but not limited to, injection molding, compression molding, casting, additive manufacturing, machining, or combinations thereof. In some embodiments, the mitigating element may be formed as a monolithic component. In other embodiments, portions may be formed separately and subsequently assembled.

In certain embodiments, as illustrated for example in FIGS. 4 and 5, the mechanically compliant mitigating element 28 may comprise a substantially planar bottom surface 38, an upper surface 40 opposite the bottom surface, and an upstanding lip 42 extending along at least a portion of a perimeter of the upper surface. The upstanding lip 42 may function to position, align, retain, and/or interface with portions of the battery component 10, a support structure, retention structures, and/or other elements of the mechanical excitation attenuation barrier 12. In some embodiments, an upper portion of the upstanding lip 42 may curve outwardly to form an overhang 44. The overhang 44 may assist in defining spacing, positional alignment, retention, load transfer characteristics, and/or interface behavior between the mechanically compliant mitigating element 28 and adjacent structural components. The geometry, dimensions, and configuration of the lip 42 and/or overhang 44 may vary depending on application requirements and are not limited to the specific example illustrated.

In certain embodiments, the mechanically compliant mitigating element 28 may include at least one isolator 48 extending from the mitigating element. The at least one isolator 48 may be configured to deform under load and attenuate transmission of mechanical excitation. In some embodiments, the at least one isolator may exhibit quasi-zero stiffness behavior, negative stiffness behavior, nonlinear stiffness behavior, or other stiffness characteristics configured to reduce transmissibility of mechanical excitation. The quantity, size, geometry, material properties, and/or arrangement of the at least one isolator may be selected to achieve desired attenuation characteristics and/or system natural frequency.

In certain embodiments, the mechanically compliant mitigating element 28 may include at least one additional mechanically compliant feature 50 configured to provide attenuation of mechanical excitation under selected loading conditions. Such features may engage under higher loads, transient events, or shock conditions, or may provide progressive stiffness characteristics. These features may be configured independently of, or in combination with, the at least one isolator 48.

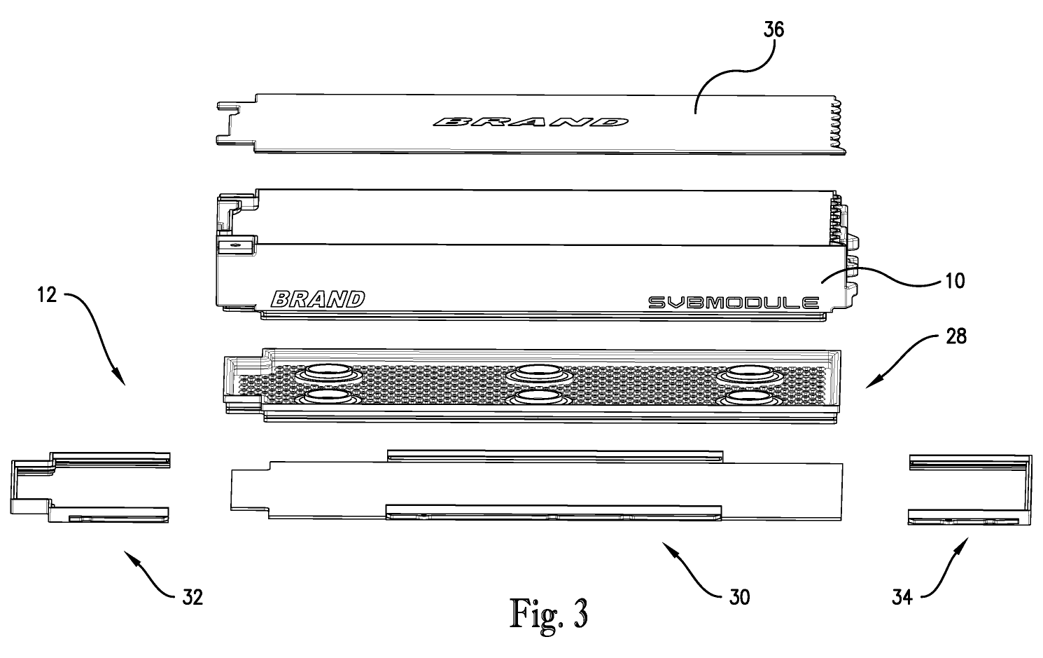

In certain embodiments, as illustrated for example in FIGS. 2 and 3, the mechanical excitation attenuation barrier 12 may include a support structure, which in some embodiments may comprise a base plate 30 configured to support and interface with the mechanically compliant mitigating element 28 and the battery component 10. The support structure or base plate 30 may comprise a bottom surface 52 configured to interface with an external structure, and an upper surface 54 configured to support and/or interface with the mechanically compliant mitigating element 28. In some embodiments, the support structure or base plate 30 may include an upstanding lip 56 extending along at least a portion of the perimeter of the upper surface 54 and/or a ledge 58 extending outwardly from the lip. The lip 56 and/or ledge 58 may function to assist with positioning, retention, load transfer, alignment, and/or structural interfacing between the support structure or base plate 30, the mechanically compliant mitigating element 28, retention structures, and/or other components. The geometry, extent, configuration, and implementation of the support structure, including embodiments comprising a base plate 30, may vary depending on application requirements and are not limited to the specific example illustrated.

Retention structures, including, but not limited to, clamps 32, 34 shown in FIG. 2, may be configured to capture and retain the mechanically compliant mitigating element 28 relative to the support structure 30 while preserving the primary mechanical load path through the mechanically compliant mitigating element. In the illustrated embodiment, each clamp 32, 34 may include an end wall 62 and one or more extending members or legs 64 configured to engage portions of the mechanically compliant mitigating element 28 and/or adjacent structural features. One or more recesses 68, 70 may be provided to facilitate engagement, positioning, and/or retention of the mechanically compliant mitigating element 28. These features may cooperate to constrain unintended displacement while permitting controlled deformation of the mechanically compliant mitigating element under load. However, the specific geometry, quantity, arrangement, and/or configuration of retention structures may vary widely depending on application requirements, and alternative retention mechanisms may be used without departing from the architectural principles described herein.

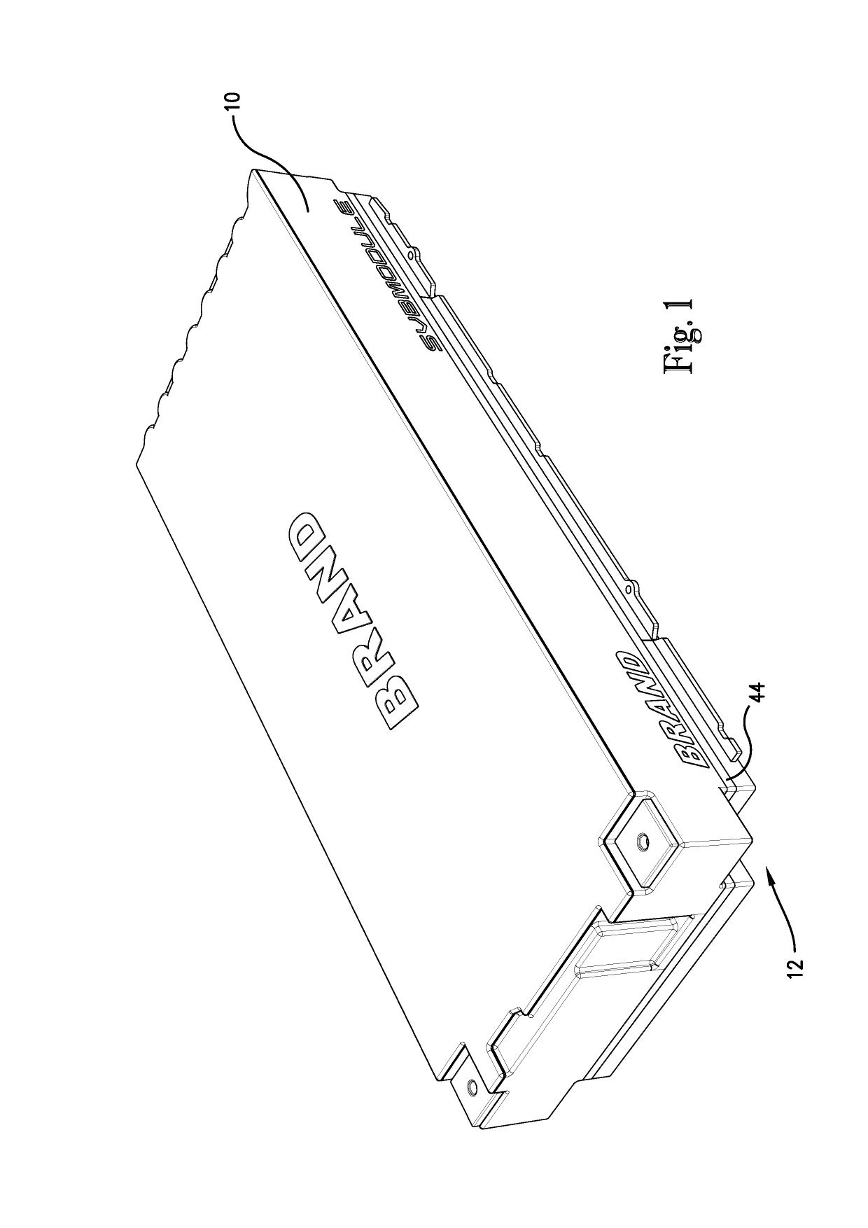

A cover structure 36, shown in FIGS. 1 and 2, may form at least a portion of an enclosure of the battery component 10 and may cooperate with other enclosure structures, including shell 14 and associated housing features, to define an enclosed volume configured to contain electrochemical components, electrical interfaces, and/or associated internal structures. The cover structure 36 may be formed from rigid, semi-rigid, or compliant materials including, but not limited to, polymers, composites, metals, or combinations thereof. The cover structure 36 may provide environmental protection, structural integrity, containment, sealing, and/or user-interface functionality, including labeling, identification markings, instructions, or branding. In some embodiments, the cover structure 36 may cooperate with the mechanical excitation attenuation barrier 12 and/or associated structural features to maintain positional stability and enclosure integrity of the battery component 10. However, the specific configuration, geometry, and/or functional integration of the cover structure 36 may vary widely depending on application requirements, and the mechanical excitation attenuation barrier 12 may operate independently of any particular cover structure configuration.

Assembly of an example embodiment of the mechanical excitation attenuation barrier assembly 12 relative to a battery component 10 will now be described with reference to FIG. 2. In this example embodiment, a mechanically compliant mitigating element 28, which may comprise at least one isolator 48 and associated structural features, is positioned adjacent to a lower portion of the shell or enclosure 14 of the battery component 10. In some embodiments, the mechanically compliant mitigating element 28 is received at least partially within a channel 24 defined by a lower section 22 of the battery component 10 beneath an upper section 20, the channel 24 being bounded at least in part by a retaining flange 26. The mechanically compliant mitigating element 28 may be positioned such that at least one isolator 48 is located between the battery component 10 and a support structure 30, thereby establishing at least a portion of a primary mechanical load path through the mechanically compliant mitigating element 28. In some embodiments, the mechanically compliant mitigating element 28 and the battery component 10 are positioned relative to the support structure 30 such that mechanical loads acting on the battery component 10 are transmitted through the mechanically compliant mitigating element 28 prior to reaching the support structure 30. One or more retention structures 32, 34 may be positioned to capture, constrain, and/or retain the mechanically compliant mitigating element 28 relative to the support structure 30 and/or the battery component 10. The mechanically compliant mitigating element 28 may be configured to provide mechanical excitation attenuation while simultaneously supporting static loads, dynamic loads, and/or combined loading conditions associated with the battery component 10. In some embodiments, assembly may be performed without modification of internal electrochemical components of the battery component 10, and may be performed during manufacturing, installation, servicing, retrofit, or other lifecycle phases. The specific assembly sequence, spatial relationship, and/or interface configuration shown in FIG. 2 represents one example embodiment and should not be construed as limiting, as alternative configurations, arrangements, and/or assembly methods may be employed while preserving attenuation of mechanical excitation within a primary mechanical load path.

With continued reference to FIG. 2, one or more retention structures 32, 34 may be positioned relative to the support structure 30 and the mechanically compliant mitigating element 28 to capture, constrain, and/or retain the mechanically compliant mitigating element 28 and associated at least one isolator 48 in a desired position relative to the support structure 30. In some embodiments, each retention structure 32, 34 may comprise an end wall 62 and one or more extending legs 64 configured to engage corresponding portions of the mechanically compliant mitigating element 28 and/or the support structure 30. One or more recesses 68 formed in the end wall 62 and/or recesses 70 formed in the extending legs 64 may be configured to receive, engage, or interface with corresponding portions of the mechanically compliant mitigating element 28, thereby facilitating retention and alignment, although other engagement geometries, retention configurations, and/or interface structures may be used. The retention structures 32, 34 may be secured to the support structure 30 using one or more attachment mechanisms, including, but not limited to, adhesives, welding, fasteners, interference fit, mechanical engagement, over-molding, bonding, or combinations thereof. In some embodiments, the retention structures 32, 34 constrain displacement of the mechanically compliant mitigating element 28 along one or more directions, including lateral, longitudinal, and/or vertical directions, while permitting controlled deformation, compression, and/or displacement of the at least one isolator 48 under load, such that mechanical load transfer between the support structure 30 and the battery component 10 occurs primarily through the mechanically mitigating element 28. By capturing and retaining the mechanically compliant mitigating element 28 relative to the support structure 30, the retention structures 32, 34 help ensure that mechanical loads transmitted between the support structure 30 and the battery component 10 pass through the mechanically compliant mitigating element 28 as part of the primary mechanical load path defined by the mechanical excitation attenuation barrier 12. This structural relationship may enable attenuation of mechanical excitation transmitted between the support structure 30 and the battery component 10 while maintaining positional stability, structural support, and load transfer integrity. In some embodiments, the retention structures 32, 34 may constrain vertical displacement of the mechanically compliant mitigating element 28 to maintain alignment, positional stability, and/or load path integrity while still permitting controlled deformation, compression, and/or displacement of the at least one isolator 48 necessary to attenuate mechanical excitation. The specific configuration, geometry, quantity, and/or attachment method of the retention structures 32, 34 may vary depending on application requirements and should not be construed as limiting.

With continued reference to FIG. 2, when the mechanical excitation attenuation barrier 12 is assembled with the battery component 10 as described herein, the overhang 44 of the upstanding lip 42 of the mechanically compliant mitigating element 28 may be positioned such that at least a portion of the battery component 10 is mechanically supported by the mechanically compliant mitigating element 28 in a manner that spaces the battery component 10 from direct rigid contact with the support structure 30 and/or the retention structures 32, 34. In such embodiments, mechanical loads transmitted between the support structure 30 and the battery component 10 may be transmitted primarily through the mechanically compliant mitigating element 28 and the associated at least one isolator 48 as part of the primary mechanical load path defined by the mechanical excitation attenuation barrier 12. This structural arrangement may reduce or substantially limit transmission of mechanical excitation through rigid mechanical bypass paths and may enable attenuation of mechanical excitation before such excitation reaches the battery component 10. The specific geometry, configuration, and/or positioning of the overhang 44, the upstanding lip 42, the mechanically compliant mitigating element 28, and/or the retention structures 32, 34 may vary depending on application requirements and should not be construed as limiting.

With reference to FIG. 1, in some embodiments, at least a portion of the mechanical excitation attenuation barrier 12 may be externally visible when assembled with the battery component 10. For example, the upstanding lip 42 and/or the overhang 44 of the mechanically compliant mitigating element 28 may be positioned such that they remain externally observable along at least a portion of a perimeter of the battery component 10. Such externally visible configurations may facilitate visual identification, inspection, verification of proper installation, and/or differentiation of the mechanical excitation attenuation barrier 12 from conventional rigid mounting structures. In other embodiments, the mechanical excitation attenuation barrier 12 may be partially or fully concealed within surrounding structures while continuing to provide a primary mechanical load path and attenuation of mechanical excitation. The extent to which portions of the mechanical excitation attenuation barrier 12 are visible or concealed may vary depending on application requirements, packaging constraints, aesthetic considerations, and/or installation configuration, and should not be construed as limiting.

With reference to FIG. 2, in some embodiments, the mechanically compliant mitigating element 28 may be positioned at least partially within a recessed region of the battery component 10, such as the channel 24 defined between the upper section 20 and the lower section 22 and bounded by the retaining flange 26. Positioning the mechanically compliant mitigating element 28 within such a recessed region may facilitate integration of the mechanical excitation attenuation barrier 12 while minimizing increases in external dimensions of the battery component 10, including overall length, width, and/or height. However, formation of a recessed region or channel 24 is not required. In other embodiments, the mechanical excitation attenuation barrier 12 may be positioned external to, flush with, or otherwise adjacent to one or more surfaces of the battery component 10 while still providing a primary mechanical load path and attenuating mechanical excitation. Accordingly, the mechanical excitation attenuation barrier 12 may be configured to occupy a limited volumetric envelope relative to the battery component 10 regardless of whether a channel, recess, or other receiving structure is present, and the specific geometry, dimensions, and/or integration configuration should not be construed as limiting.

With continued reference to FIGS. 4 and 5, the at least one isolator 48 and/or associated at least one mechanically compliant feature 50 of the mechanically compliant mitigating element 28 may be configured to provide mechanical excitation attenuation while supporting static, dynamic, and/or combined mechanical loads transmitted through the mechanical excitation attenuation barrier 12. In some embodiments, the at least one isolator 48 may exhibit linear stiffness, non-linear stiffness, progressive stiffness, staged stiffness, reduced incremental stiffness over a portion of its deflection range, and/or other stiffness profiles suitable for attenuating mechanical excitation while maintaining load-bearing capability. Such stiffness behavior may be achieved through selection and/or configuration of isolator geometry, material composition, durometer, internal structure, preload condition, spatial arrangement, and/or combinations thereof. In certain embodiments, the at least one isolator 48 may be configured such that its effective stiffness varies over its operational range, thereby enabling attenuation of mechanical excitation across one or more frequency ranges while maintaining structural support of the battery component 10 as part of the primary mechanical load path defined by the mechanical excitation attenuation barrier 12. The specific stiffness characteristics, response behavior, and/or configuration of the at least one isolator 48 may vary depending on application requirements and should not be construed as limiting.

In certain optional embodiments, the at least one isolator 48 may be configured to exhibit quasi-zero stiffness behavior over at least a portion of its operational deflection range. As used herein, quasi-zero stiffness behavior refers to stiffness characteristics in which incremental stiffness is reduced relative to other portions of the deflection range, thereby permitting increased compliance under dynamic excitation while maintaining load-bearing capability. Such behavior may be achieved through selection and/or configuration of isolator geometry, internal structure, material properties, preload conditions, spatial arrangement, and/or combinations thereof. In certain embodiments, quasi-zero stiffness behavior may facilitate attenuation of mechanical excitation while maintaining support of static and/or dynamic loads transmitted through the mechanical excitation attenuation barrier 12. However, quasi-zero stiffness behavior is not required, and the at least one isolator 48 may exhibit any stiffness profile suitable for supporting the battery component 10 while attenuating mechanical excitation.

With reference to FIGS. 4 and 5, in certain embodiments, each isolator 48 may comprise an outer ring portion 80, an inner ring portion 82 positioned inwardly relative to the outer ring portion 80, and one or more compliant connecting portions or webs 84 extending between the outer ring portion 80 and the inner ring portion 82. The inner ring portion 82 may be positioned at an elevation above or below portions of the outer ring portion 80, depending on embodiment, and the web 84 may permit controlled deformation under load. In certain embodiments, the at least one isolator 48 may be integrally formed with the mechanically compliant mitigating element 28. In other embodiments, the at least one isolator 48 may be separately formed and subsequently attached, bonded, over-molded, inserted, or otherwise coupled to the mechanically compliant mitigating element 28. The specific geometry, structural configuration, material composition, and/or attachment method of the at least one isolator 48 may vary and should not be construed as limiting.

The at least one isolator 48 may be configured to deform in response to mechanical loads transmitted through the mechanical excitation attenuation barrier 12, including, but not limited to, compressive, shear, torsional, bending, and/or combined loading conditions. Such deformation may occur between unloaded and loaded states as the battery component 10 transmits mechanical loads including, but not limited to, static loads, dynamic loads, and/or transient mechanical excitation. Controlled deformation of the at least one isolator 48 may facilitate attenuation of mechanical excitation while maintaining structural support and load transfer through the primary mechanical load path defined by the mechanical excitation attenuation barrier 12.

The quantity, size, geometry, material composition, and/or spatial arrangement of the at least one isolator 48 may be selected, configured, and/or tuned to achieve desired load-bearing capability, stability, load distribution, and/or attenuation objectives. In some embodiments, fewer or greater numbers of isolators 48 may be used depending on characteristics of the battery component 10, including, but not limited to, mass, geometry, center of gravity, mounting configuration, and/or anticipated mechanical excitation conditions. The at least one isolator 48 may be arranged symmetrically, asymmetrically, distributed across one or more regions, and/or configured in other arrangements depending on application requirements, and the specific quantity and arrangement should not be construed as limiting.

In certain illustrative embodiments, at least one isolator 48 may exhibit dimensions, geometries, and/or structural features selected to achieve desired mechanical performance characteristics. However, specific dimensions, geometries, or proportions illustrated in the figures or described herein are provided for illustrative purposes only and should not be construed as limiting. The at least one isolator 48 may be configured with any suitable dimensions and/or configurations capable of supporting the battery component 10 while attenuating mechanical excitation.

With continued reference to FIGS. 4 and 5, the mechanically compliant mitigating element 28 may further comprise one or more secondary mechanically compliant features 50 extending from the upper surface 40 of the mechanically compliant mitigating element 28. In certain embodiments, the at least one secondary mechanically compliant feature 50 may engage the battery component 10 under higher load conditions, transient shock events, or extreme mechanical excitation conditions. The at least one secondary mechanically compliant feature 50 may be configured to provide supplemental mechanical excitation attenuation, load distribution, and/or structural protection under selected operating conditions.

The quantity, geometry, spacing, material composition, and/or mechanical characteristics of the at least one secondary mechanically compliant feature 50 may be selected and/or configured to achieve desired mechanical excitation attenuation performance, load distribution characteristics, and/or structural behavior. In certain embodiments, the at least one secondary mechanically compliant feature 50 may be configured to engage only under predetermined load conditions, while in other embodiments such features may remain disengaged during normal operating conditions.

Functions of the at least one isolator 48 and the at least one secondary mechanically compliant feature 50 will now be described with reference to FIG. 5. When the battery component 10 is in a static state or otherwise subjected to static loading conditions, the weight of the battery component 10 may be supported primarily by the at least one isolator 48, which may be in an uncompressed or partially compressed state depending on load magnitude, isolator configuration, and/or system characteristics. When the battery component 10 is subjected to dynamic loading conditions, including, but not limited to, vibration, shock, impact events, transient excitation, and/or other mechanical excitation, the at least one isolator 48 may deform, compress, shear, and/or otherwise mechanically respond in a controlled manner. Such controlled mechanical response may attenuate transmission of mechanical excitation through the mechanical excitation attenuation barrier 12 while maintaining structural support and preserving the primary mechanical load path between the battery component 10 and the support structure 30. In some embodiments, the at least one secondary mechanically compliant feature 50 may engage under higher load conditions to provide supplemental support, limit displacement, control deformation, and/or protect against extreme loading conditions. The specific behavior, configuration, and/or interaction of the at least one isolator 48 and the at least one secondary mechanically compliant feature 50 may vary depending on embodiment and should not be construed as limiting.

When the battery component 10 is subjected to mechanical excitation, including vibration, shock, and/or other transient or dynamic loading conditions, the at least one isolator 48 may deform, compress, deflect, and/or otherwise respond in a mechanically compliant manner to attenuate transmission of mechanical excitation between the support structure 30 and the battery component 10. Such deformation may reduce transmissibility of mechanical excitation to the battery component 10 while maintaining structural support and preservation of the primary mechanical load path defined by the mechanical excitation attenuation barrier 12. In some embodiments, the at least one isolator 48 may exhibit nonlinear stiffness characteristics, including quasi-zero stiffness behavior over one or more portions of its operating range, which may facilitate reduction of system natural frequency, attenuation of mechanical excitation across one or more frequency ranges, and/or improved isolation performance. However, quasi-zero stiffness behavior is not required, and the mechanical excitation attenuation barrier 12 may operate effectively using isolators exhibiting linear, nonlinear, and/or other mechanically compliant characteristics depending on application requirements.

Under static conditions and/or relatively low levels of mechanical excitation, the battery component 10 may be supported primarily by the at least one isolator 48, with a lower portion of the battery component 10 spaced from or not substantially supported by the at least one secondary mechanically compliant feature 50. In such conditions, the at least one isolator 48 may define the primary mechanical load path between the battery component 10 and the support structure 30, thereby enabling attenuation of mechanical excitation while maintaining positional stability and structural support. Because the at least one isolator 48 may be configured to exhibit selected stiffness, damping, and/or compliance characteristics, transmission of mechanical excitation to the battery component 10 may be reduced while preserving structural integrity and alignment. Limiting contact primarily to the at least one isolator 48 under such conditions may also reduce unintended rigid mechanical coupling and/or secondary load paths that could otherwise transmit mechanical excitation to the battery component 10. However, the specific load-sharing relationship between the at least one isolator 48 and the at least one secondary mechanically compliant feature 50 may vary depending on loading conditions, system configuration, and/or application requirements, and should not be construed as limiting.

Under increased mechanical excitation conditions, including, but not limited to, higher-magnitude vibration, shock, impact, or other transient mechanical loading, the battery component 10 may move relative to the support structure 30 such that the at least one isolator 48 undergoes increased deformation, compression, and/or displacement. In such conditions, the at least one secondary mechanically compliant feature 50 may engage, contact, and/or support at least a portion of the load of the battery component 10 in combination with the at least one isolator 48. This progressive engagement may increase effective load-bearing capacity, modify stiffness characteristics, and/or provide additional attenuation of mechanical excitation while preserving structural integrity and positional stability. The cooperative interaction between the at least one isolator 48 and the at least one secondary mechanically compliant feature 50 may allow the mechanical excitation attenuation barrier 12 to accommodate a wide range of loading conditions while maintaining attenuation performance and load path integrity. The relative engagement, load sharing, geometry, quantity, configuration, and/or activation threshold of the at least one isolator 48 and the at least one secondary mechanically compliant feature 50 may vary depending on system design, operating conditions, and/or application requirements, and should not be construed as limiting.

The mechanical excitation attenuation barrier 12 and associated support architectures described herein may be implemented to support a battery component 10, including, but not limited to, a battery, battery module, and/or battery assembly, across a wide range of applications and lifecycle phases, including, but not limited to, transportation, installation, operation, servicing, relocation, storage, and/or redeployment. In such applications, the mechanical excitation attenuation barrier 12 may be positioned between the battery component 10 and a support structure 30 such that mechanical loads transmitted between the battery component 10 and the support structure 30 pass through the mechanical excitation attenuation barrier 12 as part of a primary mechanical load path while mechanical excitation is attenuated. The mechanical excitation attenuation barrier 12 may be configured to operate under static loading conditions, dynamic loading conditions, transient loading conditions, and/or combinations thereof, and may accommodate variations in orientation, mounting configuration, structural interface, and/or operating environment with or without requiring modification of internal electrochemical components of the battery component 10. The applicability of the mechanical excitation attenuation barrier 12 across diverse deployment scenarios, system architectures, and/or lifecycle phases should not be construed as limiting.

The systems, structures, and methods described herein may be implemented across a wide range of application environments, including, but not limited to, mobile platforms, stationary installations, industrial systems, transportation systems, and distributed energy storage deployments. Example applications may include electric vehicles, hybrid vehicles, off-road equipment, marine platforms, aerospace systems, robotics, material handling equipment, backup power systems, infrastructure-mounted energy storage systems, and grid-connected storage installations. In such embodiments and other embodiments, the mechanical excitation attenuation barrier 12 may be configured to support a battery component 10 while attenuating transmission of mechanical excitation and maintaining a primary mechanical load path, regardless of application-specific mounting configuration, operational environment, or system architecture.

The mechanical excitation attenuation barrier 12 and associated components, including the mechanically compliant mitigating element 28, the at least one isolator 48, the support structure 30, and one or more retention structures 32, 34, may be manufactured using a wide range of manufacturing processes, including, but not limited to, molding, casting, machining, additive manufacturing, extrusion, forming, assembly, over-molding, bonding, and combinations thereof. Suitable materials may include elastomeric materials, polymeric materials, thermoplastic materials, thermoset materials, composite materials, metallic materials, and combinations thereof. Material selection, manufacturing method, and/or assembly approach may be chosen based on performance requirements, load-bearing requirements, environmental conditions, durability considerations, cost objectives, manufacturability, and/or system integration requirements. The mechanical excitation attenuation barrier 12 may be manufactured as a monolithic component, an integrated assembly, or a modular assembly comprising multiple components configured to cooperate to provide a primary mechanical load path and attenuate mechanical excitation transmitted between an external support structure and the battery component 10.

Because the mechanical excitation attenuation barrier 12 may operate as a passive structural system, attenuation of mechanical excitation may be achieved without requiring active control systems, sensors, actuators, control electronics, or external power sources. Passive operation may reduce system complexity, cost, packaging constraints, and potential failure modes while improving reliability, durability, and/or long-term performance. The mechanical excitation attenuation barrier 12 may provide consistent attenuation of mechanical excitation across a wide range of operating conditions, including, but not limited to, transportation, installation, normal operation, servicing, relocation, storage, and/or other lifecycle phases, and may maintain attenuation performance across environmental conditions including, but not limited to, temperature variation, moisture exposure, dust, debris, chemical exposure, and/or sustained mechanical loading.

The mechanical excitation attenuation barrier 12 may be adaptable to batteries, battery modules, and/or battery assemblies of varying sizes, weights, chemistries, configurations, and/or form factors, including both presently available and future energy storage technologies. By enabling attenuation of mechanical excitation within the primary mechanical load path external to internal electrochemical components, the mechanical excitation attenuation barrier 12 may allow internal battery architectures to be optimized for electrochemical performance, manufacturability, material efficiency, and/or packaging efficiency without necessarily requiring internal structural modifications solely for mechanical excitation mitigation. This architectural separation may facilitate independent evolution of internal electrochemical design and external mechanical support structures while maintaining attenuation performance across different battery designs and deployment environments.

By attenuating transmission of mechanical excitation to the battery component 10 through the mechanical excitation attenuation barrier 12, the systems and structures described herein may reduce mechanically induced degradation of internal electrochemical components and associated structural elements. In some embodiments, such attenuation may facilitate extended service life, improved operational reliability, and/or reduced maintenance or replacement frequency. These effects may contribute to improved lifecycle efficiency and may support more efficient utilization of materials, including critical minerals and structural materials, across deployment, operation, servicing, and/or reuse phases. The degree of attenuation and associated performance outcomes may vary depending on configuration of the mechanical excitation attenuation barrier 12, characteristics of the at least one isolator 48, system mass properties, and/or operating conditions.

The mechanical excitation attenuation barrier 12 may be implemented as part of an original equipment design, installed as part of an initial system assembly, integrated into a battery component 10 during manufacture, or incorporated into an existing installation as part of a retrofit, upgrade, or reconfiguration. In some embodiments, the mechanical excitation attenuation barrier 12 may be configured for installation between the battery component 10 and an external support structure without requiring modification of internal electrochemical components of the battery component 10. Such adaptability may facilitate integration across a wide range of system architectures, mounting configurations, and deployment environments, including modular and/or scalable energy storage systems. The mechanical excitation attenuation barrier 12 may therefore support deployment flexibility, servicing flexibility, and/or lifecycle adaptability across diverse applications and operational contexts.

For purposes of this disclosure, certain terms are defined to clarify the structural, functional, and architectural aspects of the embodiments described herein. These definitions are provided to facilitate understanding of the disclosed systems, structures, and methods and to ensure consistent interpretation of terminology. Unless expressly stated otherwise, the definitions provided herein are intended to be illustrative and explanatory rather than limiting, and no definition should be construed as restricting the scope of the claimed subject matter beyond what is expressly recited in the claims.

As used herein, the term “battery” refers to an electrochemical energy storage device configured to store and release electrical energy. A battery may comprise one or more electrochemical cells arranged in any configuration, including, but not limited to, series arrangements, parallel arrangements, series-parallel arrangements, or combinations thereof. A battery may be implemented as a standalone unit, integrated device, or subcomponent of a larger system, and may include, but is not limited to, rechargeable batteries, non-rechargeable batteries, solid-state batteries, lithium-based batteries, lead-acid batteries, nickel-based batteries, sodium-based batteries, flow batteries, metal-air batteries, and/or other electrochemical energy storage technologies, whether currently known or developed in the future. Unless expressly stated otherwise, the term “battery” encompasses all electrochemical energy storage devices regardless of chemistry, voltage, form factor, size, structural configuration, or application.

As used herein, the term “battery module” refers to an assembly comprising one or more batteries and/or electrochemical cells that are mechanically, structurally, and/or electrically integrated into a modular unit. A battery module may include, but is not limited to, structural supports, housings, frames, electrical interconnects, terminals, sensing components, thermal management components, protective elements, and/or interface features. Battery modules may be used as standalone energy storage units or combined with other battery modules and/or batteries to form larger energy storage systems. The term “battery module” encompasses modular energy storage units of any size, chemistry, voltage, structural configuration, or application.

As used herein, the term “battery assembly” refers to an integrated energy storage structure comprising one or more batteries, one or more battery modules, or combinations thereof, arranged within a common structural framework, enclosure, or support architecture. A battery assembly may include, but is not limited to, structural frames, housings, enclosures, battery management systems, electrical interfaces, thermal management components, mounting features, protective structures, and/or interface elements. A battery assembly may be configured for use in vehicles, stationary energy storage systems, industrial equipment, robotics, aerospace systems, portable power systems, or other applications. The term “battery assembly” encompasses energy storage systems of any scale, voltage, chemistry, structural configuration, or application, including both presently known and future energy storage architectures.

As used herein, the term “shock” refers to a transient mechanical excitation characterized by a rapid change in acceleration, velocity, displacement, force, load, or combinations thereof occurring over a relatively short duration. Shock events may result from impacts, drops, collisions, abrupt handling, transportation events, installation events, operational events, roadway irregularities, machinery interaction, seismic activity, structural movement, or other dynamic mechanical disturbances. Shock may occur along one or more axes, including translational and/or rotational axes, and may include single-event impulses, repeated impulse events, or complex transient excitation profiles. Shock may originate from external support structures, environmental sources, operational conditions, or other structural interfaces and may be transmitted through mechanical load paths to a supported battery, battery module, and/or battery assembly. The term “shock” encompasses all transient mechanical excitation events regardless of magnitude, frequency content, duration, or source.

As used herein, the term “vibration” refers to oscillatory mechanical excitation involving motion, displacement, acceleration, force, load, strain, or combinations thereof that may occur periodically, aperiodically, continuously, intermittently, randomly, or in complex excitation patterns across one or more frequencies, amplitudes, and/or directions. Vibration may originate from operational conditions, rotating machinery, vehicle motion, transportation, structural interaction, environmental sources, seismic activity, or other dynamic mechanical influences. Vibration may occur along one or more translational axes and/or rotational axes and may include harmonic excitation, broadband excitation, resonant excitation, transient excitation, or combinations thereof. Vibration may be transmitted through structural interfaces and mechanical load paths to a supported battery, battery module, and/or battery assembly. The term “vibration” encompasses all oscillatory mechanical excitation regardless of frequency range, amplitude, waveform, or source.

As used herein, the term “passive mechanically compliant element” refers to any structural element, material, feature, structure, geometry, or assembly configured to elastically, viscoelastically, plastically, structurally, or otherwise mechanically deform, deflect, compress, shear, bend, or displace in response to applied mechanical excitation without requiring active control, powered actuation, sensors, feedback systems, or external energy input for mechanical excitation attenuation. Passive mechanically compliant elements may store, dissipate, redistribute, isolate, attenuate, or otherwise modify transmission of mechanical excitation transmitted through a mechanical load path. Such elements may comprise elastomeric materials, polymeric materials, rubber, polyurethane, thermoplastic polyurethane, metallic structures, composite structures, structural geometries, engineered compliant structures, or combinations thereof. The term encompasses discrete isolators, continuous compliant structures, distributed compliant regions, integrally formed compliant features, layered structures, cellular structures, lattice structures, and other mechanically compliant architectures, and does not require any particular material, geometry, stiffness, damping characteristic, or configuration unless expressly stated.

As used herein, the term “isolator” refers to a structure or portion of a structure that includes at least one passive mechanically compliant element and that is configured to support a battery, battery module, and/or battery assembly while attenuating transmission of mechanical excitation, including, but not limited to, shock, vibration, and/or combinations thereof. An isolator may be provided as a discrete component, as part of a mechanically compliant mitigating element 28, and/or as a continuous structure integrated into a mechanical excitation attenuation barrier 12. The at least one isolator may be implemented in various forms, including, but not limited to, sheets, pads, rails, rings, blocks, molded features, layered structures, distributed structures, and/or combinations thereof. The at least one isolator may comprise one or more materials, layers, and/or internal structures and may be integrally formed with, attached to, or separate from other components of the mechanical excitation attenuation barrier 12, including support structures 30 and/or retention structures 32, 34. The term “isolator” does not require any particular geometry, material composition, manufacturing method, stiffness characteristic, or configuration unless expressly recited in the claims.

As used herein, the term “mechanical excitation attenuation barrier” refers to a structure, system, assembly, and/or architectural feature comprising at least one passive mechanically compliant element, and may include, but not limited to, at least one isolator 48 and/or a mechanically compliant mitigating element 28, and may optionally include associated support structures 30, retention structures 32, 34, and/or interface structures. The mechanical excitation attenuation barrier 12 is configured to support a battery, battery module, and/or battery assembly and to attenuate transmission of mechanical excitation, including, but not limited to, shock, vibration, impulse loading, transient loading, sustained dynamic loading, and/or combinations thereof. The mechanical excitation attenuation barrier 12 may provide, define, and/or form at least a portion of a primary mechanical load path between the battery component 10 and an external support structure and may be implemented as a standalone component, an integrated structural feature, an external support interface, an internal structural feature, and/or a distributed structural architecture. The mechanical excitation attenuation barrier 12 may comprise one or more discrete components, continuous structures, distributed compliant regions, and/or integrally formed structural features, and may be positioned external to, internal to, and/or partially integrated with a shell, enclosure, housing, and/or structural portion of the battery component 10. The term “mechanical excitation attenuation barrier” does not require any particular geometry, material, configuration, placement, visibility, manufacturing method, or structural arrangement unless expressly recited in the claims.

As used herein, the terms “attenuates,” “attenuation,” and variations thereof refer to a reduction, modification, control, redirection, dissipation, absorption, filtering, isolation, and/or alteration in magnitude, amplitude, transmissibility, acceleration, displacement, force, energy, frequency content, and/or mechanical response characteristics of mechanical excitation transmitted from one structure to another. Attenuation does not require complete elimination of mechanical excitation and may include partial reduction, selective reduction, directional reduction, frequency-dependent reduction, and/or modification of mechanical excitation across one or more frequency ranges, directions, operating conditions, and/or loading scenarios. Attenuation may be achieved through elastic deformation, viscoelastic deformation, structural compliance, material damping, geometric configuration, interface design, load path definition, and/or combinations thereof. Attenuation may be quantified, characterized, estimated, simulated, measured, and/or inferred using transmissibility, acceleration response, displacement response, force transmission, energy dissipation, frequency response analysis, and/or other analytical, experimental, and/or computational methods, but is not limited to any specific performance threshold, measurement technique, or analytical approach unless expressly recited in the claims.

As used herein, the term “primary mechanical load path” refers to a principal structural route, pathway, interface, and/or transmission mechanism through which static loads, dynamic loads, transient loads, and/or operational loads are transmitted between a battery component 10 and an external support structure. The primary mechanical load path may include one or more passive mechanically compliant elements, including, but not limited to, the mechanically compliant mitigating element 28 and/or at least one isolator 48, and may optionally include associated support structures 30, retention structures 32, 34, and/or interface structures. A primary mechanical load path does not require exclusivity and may coexist with secondary, parallel, incidental, intermittent, and/or auxiliary load paths, provided that the mechanical excitation attenuation barrier 12 carries, defines, supports, and/or influences transmission of at least a portion of operational mechanical loads between the battery component 10 and the external support structure. The primary mechanical load path may be continuous, discontinuous, distributed, localized, direct, indirect, and/or partially shared among multiple structures, and may be defined by structural geometry, material properties, interface configuration, and/or assembly relationships. The term “primary mechanical load path” does not require any particular percentage of load transfer, structural exclusivity, or specific configuration unless expressly recited in the claims.

As used herein, the term “support structure” refers to any structure, surface, interface, component, assembly, or portion thereof configured to support, carry, transfer, react to, or otherwise bear static loads, dynamic loads, transient loads, inertial loads, operational loads, and/or environmental loads associated with a battery component 10 and/or a mechanical excitation attenuation barrier 12. A support structure may include, but is not limited to, the support structure 30 illustrated in FIG. 2, a base plate, tray, rack, shelf, frame member, rail, enclosure wall, housing structure, chassis structure, mounting structure, vehicle structure, installation structure, structural interface, or combinations thereof. A support structure may be a discrete component, an integrated portion of a larger assembly, or an existing structural element that is not specifically manufactured for mechanical excitation attenuation. The support structure may be rigid, semi-rigid, compliant, monolithic, modular, continuous, discontinuous, and/or integrally formed with other components. The term “support structure” does not require any specific geometry, material, orientation, structural configuration, or manufacturing method unless expressly recited in the claims.

As used herein, the term “retention structure” refers to any structure, feature, component, interface, mechanism, or portion thereof configured to capture, retain, constrain, position, align, secure, stabilize, and/or maintain positional relationship of a mechanically compliant mitigating element 28 and/or at least one isolator 48 relative to a support structure 30 and/or other structural components. Retention structures may include, but are not limited to, retention structures 32, 34 illustrated in FIG. 2, clips, clamps, frames, lips, flanges, fasteners, interference fits, adhesive bonds, welds, over-molded features, mechanical engagement features, integrated structural features, geometric constraint features, and/or combinations thereof. Retention structures may constrain motion along one or more axes, including lateral, longitudinal, vertical, rotational, and/or multi-axis directions, while permitting controlled deformation, compression, displacement, and/or mechanical compliance of the mechanically compliant mitigating element 28 and/or the at least one isolator 48 necessary for attenuation of mechanical excitation. Retention structures may be permanently affixed, removably affixed, integrally formed, separately formed, and/or configured for installation, replacement, servicing, or reconfiguration. The term “retention structure” does not require any specific geometry, attachment method, configuration, or structural implementation unless expressly recited in the claims.

As used herein, the terms “configured,” “configuration,” and grammatical variants thereof refer to selection, arrangement, positioning, sizing, shaping, material selection, structural design, assembly, integration, and/or adaptation of one or more components to achieve one or more desired structural, mechanical, functional, and/or operational characteristics. Configuration may occur during design, manufacturing, assembly, installation, servicing, reconfiguration, and/or operation. The term does not require active adjustment, active control, continuous adjustment, or electronic control unless expressly recited in the claims.

As used herein, the term “natural frequency” refers to a frequency at which a mechanical system exhibits a resonant or characteristic response to mechanical excitation. Natural frequency may be influenced by system mass, stiffness, damping, geometry, material properties, load distribution, boundary conditions, preload conditions, and/or structural configuration. References to a system having, targeting, achieving, maintaining, or exhibiting a specified natural frequency, including values at or below a specified threshold, refer to systems configured such that the combined structural and mechanical properties of the battery component 10, the mechanical excitation attenuation barrier 12, and associated structures produce such frequency characteristics under one or more operating conditions.

As used herein, the term “external support structure” refers to any structure external to the battery component 10 that provides mechanical support, mounting, constraint, or load transfer. External support structures may include, but are not limited to, vehicle frames, chassis members, racks, trays, enclosures, structural housings, installation structures, transportation structures, industrial structures, building structures, mounting interfaces, or combinations thereof. External support structures may be stationary or mobile and may include original equipment structures, retrofit structures, or integrally formed structural elements.

### ADDITIONAL CONSIDERATIONS

The detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The detailed description is, therefore, not to be taken in a limiting sense. The scope of the current invention is defined only by the appended claims, along with the full scope of equivalents to which such claims are entitled.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. An integrated energy storage support assembly comprising:
a battery selected from the group consisting of a battery, a battery module, and a battery
assembly; and
a mechanical excitation attenuation barrier structurally interposed between the battery
and an external support structure,
wherein the mechanical excitation attenuation barrier comprises at least one passive
mechanically compliant element configured to attenuate transmission of
mechanical excitation to the battery,
wherein the mechanical excitation attenuation barrier defines a primary mechanical load
path between the battery and an external support structure through the
mechanical excitation attenuation barrier, and
wherein the battery and the mechanical excitation attenuation barrier together form a
passive isolation system configured to attenuate transmission of mechanical
excitation to the battery.

2. The assembly of claim 1, wherein the passive mechanically compliant element comprises at least one isolator.

3. The assembly of claim 1, wherein the mechanical excitation attenuation barrier includes at least one isolator.

4. The assembly of claim 2, wherein the at least one isolator defines at least a portion of the primary mechanical load path.

5. The assembly of claim 3, wherein the at least one isolator defines at least a portion of the primary mechanical load path.

6. The assembly of claim 1, wherein the mechanical excitation attenuation barrier is configured to attenuate mechanical excitation selected from shock, vibration, random vibration, impulse loading, impact loading, transient mechanical loading, sustained dynamic loading, oscillatory excitation, resonant excitation, harmonic excitation, broadband mechanical excitation, cyclic loading, transportation-induced excitation, operational excitation, handling-induced excitation, installation-induced excitation, environmental excitation, or any other form of mechanical excitation capable of being transmitted to the battery, or combinations thereof.

7. The assembly of claim 1, wherein the passive mechanically compliant element comprises a polymeric material, elastomeric material, rubber, silicone, polyurethane, thermoplastic polyurethane, thermoplastic elastomer, viscoelastic material, foam material, gel material, composite material, fluoropolymer, nitrile rubber, neoprene, EPDM, or any other mechanically compliant material capable of attenuating transmission of mechanical excitation, or combinations thereof.

8. The assembly of claim 2, wherein the at least one isolator comprises a polymeric material, elastomeric material, rubber, silicone, polyurethane, thermoplastic polyurethane, thermoplastic elastomer, viscoelastic material, foam material, gel material, composite material, fluoropolymer, nitrile rubber, neoprene, EPDM, or any other mechanically compliant material capable of attenuating transmission of mechanical excitation, or combinations thereof.

9. The assembly of claim 3, wherein the at least one isolator comprises a polymeric material, elastomeric material, rubber, silicone, polyurethane, thermoplastic polyurethane, thermoplastic elastomer, viscoelastic material, foam material, gel material, composite material, fluoropolymer, nitrile rubber, neoprene, EPDM, or any other mechanically compliant material capable of attenuating transmission of mechanical excitation, or combinations thereof.

10. The assembly of claim 1, wherein the passive mechanically compliant element comprises a mechanically compliant structure including a continuous sheet, pad, rail, ring, block, molded feature, elastomeric body, compressible element, compliant interface layer, lattice structure, cellular structure, web-supported structure, ribbed structure, hollow structure, monolithic structure, multi-component structure, or any other mechanically compliant structure configured to attenuate transmission of mechanical excitation, or combinations thereof.

11. The assembly of claim 2, wherein the at least one isolator comprises a mechanically compliant structure including a continuous sheet, pad, rail, ring, block, molded feature, elastomeric body, compressible element, compliant interface layer, lattice structure, cellular structure, web-supported structure, ribbed structure, hollow structure, monolithic structure, multi-component structure, or any other mechanically compliant structure configured to attenuate transmission of mechanical excitation, or combinations thereof.

12. The assembly of claim 3, wherein the at least one isolator comprises a mechanically compliant structure including a continuous sheet, pad, rail, ring, block, molded feature, elastomeric body, compressible element, compliant interface layer, lattice structure, cellular structure, web-supported structure, ribbed structure, hollow structure, monolithic structure, multi-component structure, or any other mechanically compliant structure configured to attenuate transmission of mechanical excitation, or combinations thereof.

13. The assembly of claim 1, wherein the passive isolation system is configured to achieve, target, select, or maintain a natural frequency of 200 Hz or less.

14. The assembly of claim 1, wherein at least a portion of the mechanical excitation attenuation barrier is externally visible.

15. The assembly of claim 1, wherein at least a portion of the mechanical excitation attenuation barrier is concealed from external view.

16. The assembly of claim 1, wherein the mechanical excitation attenuation barrier is positioned external to electrochemical components of the battery.

17. The assembly of claim 1, wherein the mechanical excitation attenuation barrier occupies less than 25% of an internal volumetric capacity of the battery configured to house electrochemical components.

18. The assembly of claim 17, wherein the internal volumetric capacity excludes external housings, covers, mounting features, and non-electrochemical structural components.

19. The assembly of claim 1, wherein mechanical loads transmitted between the battery and the external support structure pass through the mechanical excitation attenuation barrier.

20. The assembly of claim 19, wherein any additional physical connections between the battery and the external support structure do not define a load-bearing path for transmitting mechanical loads between the battery and the external support structure.

21. The assembly of claim 19, wherein rigid mechanical bypass paths between the battery and the external support structure are eliminated or rendered mechanically compliant.

22. The assembly of claim 1, wherein the battery includes an enclosure, and wherein the mechanical excitation attenuation barrier is positioned external to the enclosure.

23. The assembly of claim 1, wherein mechanical excitation transmitted between the external support structure and the battery is attenuated by the passive mechanically compliant element within the primary mechanical load path.

24. The assembly of claim 1, wherein the battery is housed within an enclosure, and wherein the mechanical excitation attenuation barrier is structurally interposed between the enclosure and the external support structure such that mechanical excitation transmitted from the external support structure to the enclosure is attenuated by the passive mechanically compliant element.

25. The assembly of claim 24, wherein the mechanical excitation attenuation barrier structurally supports the enclosure relative to the external support structure.

26. The assembly of claim 24, wherein the mechanical excitation attenuation barrier defines a structural interface between the enclosure and the external support structure.

27. The assembly of claim 24, wherein the mechanical excitation attenuation barrier is positioned entirely external to the enclosure.

28. The assembly of claim 24, wherein mechanical loads transmitted between the enclosure and the external support structure pass through the mechanical excitation attenuation barrier.

29. The assembly of claim 24, wherein the passive mechanically compliant element is positioned between the enclosure and the external support structure.

30. An energy storage device selected from the group consisting of a battery, a battery
module, a battery pack, and a battery assembly, comprising:
an enclosure housing electrochemical components; and
a mechanical excitation attenuation barrier comprising at least one passive mechanically
compliant element configured to attenuate transmission of mechanical excitation to the electrochemical components,
wherein the mechanical excitation attenuation barrier is positioned relative to the
enclosure such that mechanical loads transmitted to the enclosure pass through the passive mechanically compliant element, and
wherein the mechanical excitation attenuation barrier is configured to be structurally
interposed between the enclosure and an external support structure when the energy storage device is installed.

31. The energy storage device of claim 30, wherein the passive mechanically compliant element comprises at least one isolator.

32. The energy storage device of claim 30, wherein the mechanical excitation attenuation barrier includes at least one isolator.

33. The energy storage device of claim 31, wherein the at least one isolator defines at least a portion of a load path through which mechanical loads are transmitted to the enclosure.

34. The energy storage device of claim 32, wherein the at least one isolator defines at least a portion of a load path through which mechanical loads are transmitted to the enclosure.

35. The energy storage device of claim 30, wherein the mechanical excitation attenuation barrier is configured to attenuate mechanical excitation selected from shock, vibration, random vibration, impulse loading, impact loading, transient mechanical loading, sustained dynamic loading, oscillatory excitation, resonant excitation, harmonic excitation, broadband mechanical excitation, cyclic loading, transportation-induced excitation, operational excitation, handling-induced excitation, installation-induced excitation, environmental excitation, or any other form of mechanical excitation capable of being transmitted to the battery, or combinations thereof.

36. The energy storage device of claim 30, wherein the passive mechanically compliant element comprises a polymeric material, elastomeric material, rubber, silicone, polyurethane, thermoplastic polyurethane, thermoplastic elastomer, viscoelastic material, foam material, gel material, composite material, fluoropolymer, nitrile rubber, neoprene, EPDM, or any other mechanically compliant material capable of attenuating transmission of mechanical excitation, or combinations thereof.

37. The energy storage device of claim 31, wherein the at least one isolator comprises a polymeric material, elastomeric material, rubber, silicone, polyurethane, thermoplastic polyurethane, thermoplastic elastomer, viscoelastic material, foam material, gel material, composite material, fluoropolymer, nitrile rubber, neoprene, EPDM, or any other mechanically compliant material capable of attenuating transmission of mechanical excitation, or combinations thereof.

38. The energy storage device of claim 32, wherein the at least one isolator comprises a polymeric material, elastomeric material, rubber, silicone, polyurethane, thermoplastic polyurethane, thermoplastic elastomer, viscoelastic material, foam material, gel material, composite material, fluoropolymer, nitrile rubber, neoprene, EPDM, or any other mechanically compliant material capable of attenuating transmission of mechanical excitation, or combinations thereof.

39. The energy storage device of claim 30, wherein the passive mechanically compliant element comprises a mechanically compliant structure including a continuous sheet, pad, rail, ring, block, molded feature, elastomeric body, compressible element, compliant interface layer, lattice structure, cellular structure, web-supported structure, ribbed structure, hollow structure, monolithic structure, multi-component structure, or any other mechanically compliant structure configured to attenuate transmission of mechanical excitation, or combinations thereof.

40. The energy storage device of claim 31, wherein the at least one isolator comprises a mechanically compliant structure including a continuous sheet, pad, rail, ring, block, molded feature, elastomeric body, compressible element, compliant interface layer, lattice structure, cellular structure, web-supported structure, ribbed structure, hollow structure, monolithic structure, multi-component structure, or any other mechanically compliant structure configured to attenuate transmission of mechanical excitation, or combinations thereof.

41. The energy storage device of claim 32, wherein the at least one isolator comprises a mechanically compliant structure including a continuous sheet, pad, rail, ring, block, molded feature, elastomeric body, compressible element, compliant interface layer, lattice structure, cellular structure, web-supported structure, ribbed structure, hollow structure, monolithic structure, multi-component structure, or any other mechanically compliant structure configured to attenuate transmission of mechanical excitation, or combinations thereof.

42. The energy storage device of claim 30, wherein a passive isolation system formed by the energy storage device and the mechanical excitation attenuation barrier is configured to achieve, target, select, or maintain a natural frequency of 200 Hz or less.

43. The energy storage device of claim 30, wherein at least a portion of the mechanical excitation attenuation barrier is externally visible.

44. The energy storage device of claim 30, wherein at least a portion of the mechanical excitation attenuation barrier is concealed from external view.

45. The energy storage device of claim 30, wherein the mechanical excitation attenuation barrier is positioned external to electrochemical components of the energy storage device.

46. The energy storage device of claim 30, wherein the mechanical excitation attenuation barrier is positioned external to the enclosure.

47. The energy storage device of claim 30, wherein the mechanical excitation attenuation barrier occupies less than 25% of an internal volumetric capacity of the energy storage device configured to house electrochemical components.

48. The energy storage device of claim 47, wherein the internal volumetric capacity excludes external housings, covers, mounting features, and non-electrochemical structural components.

49. The energy storage device of claim 30, wherein mechanical loads transmitted between the energy storage device and an external support structure pass through the mechanical excitation attenuation barrier when the energy storage device is installed.

50. The energy storage device of claim 49, wherein any additional physical connections between the energy storage device and the external support structure do not define a load-bearing path for transmitting mechanical loads between the energy storage device and the external support structure when the energy storage device is installed.

51. The energy storage device of claim 49, wherein rigid mechanical bypass paths between the energy storage device and the external support structure are eliminated or rendered mechanically compliant when the energy storage device is installed.

52. The energy storage device of claim 30, wherein the enclosure defines an external boundary of the energy storage device, and wherein the mechanical excitation attenuation barrier is positioned external to the enclosure.

53. The energy storage device of claim 30, wherein mechanical excitation transmitted between an external support structure and the energy storage device is attenuated by the passive mechanically compliant element when the energy storage device is installed.

54. The energy storage device of claim 30, wherein the mechanical excitation attenuation barrier is configured to be structurally interposed between the enclosure and an external support structure when the energy storage device is installed such that mechanical excitation transmitted from the external support structure to the enclosure is attenuated by the passive mechanically compliant element.

55. The energy storage device of claim 54, wherein the mechanical excitation attenuation barrier structurally supports the enclosure relative to the external support structure when the energy storage device is installed.

56. The energy storage device of claim 54, wherein the mechanical excitation attenuation barrier defines a structural interface between the enclosure and the external support structure when the energy storage device is installed.

57. The energy storage device of claim 54, wherein the mechanical excitation attenuation barrier is positioned entirely external to the enclosure.

58. The energy storage device of claim 54, wherein mechanical loads transmitted between the enclosure and the external support structure pass through the mechanical excitation attenuation barrier when the energy storage device is installed.

59. The energy storage device of claim 54, wherein the passive mechanically compliant element is positioned between the enclosure and the external support structure when the energy storage device is installed.

60. A support structure configured to support an energy storage device, comprising:
a structural member configured to support an energy storage device; and
a mechanical excitation attenuation barrier positioned relative to the structural member,
wherein the mechanical excitation attenuation barrier comprises at least one passive
mechanically compliant element configured to attenuate transmission of mechanical excitation from the structural member to the energy storage device, and
wherein mechanical loads transmitted between the structural member and the energy
storage device pass through the passive mechanically compliant element when the energy storage device is installed.

61. The support structure of claim 60, wherein the passive mechanically compliant element comprises at least one isolator.

62. The support structure of claim 60, wherein the mechanical excitation attenuation barrier includes at least one isolator.

63. The support structure of claim 61, wherein the at least one isolator defines at least a portion of a load path through which mechanical loads are transmitted between the structural member and the energy storage device when the energy storage device is installed.

64. The support structure of claim 62, wherein the at least one isolator defines at least a portion of a load path through which mechanical loads are transmitted between the structural member and the energy storage device when the energy storage device is installed.

65. The support structure of claim 60, wherein the mechanical excitation attenuation barrier is configured to attenuate mechanical excitation selected from shock, vibration, random vibration, impulse loading, impact loading, transient mechanical loading, sustained dynamic loading, oscillatory excitation, resonant excitation, harmonic excitation, broadband mechanical excitation, cyclic loading, transportation-induced excitation, operational excitation, handling-induced excitation, installation-induced excitation, environmental excitation, or any other form of mechanical excitation capable of being transmitted from the structural member to the energy storage device, or combinations thereof.

66. The support structure of claim 60, wherein the passive mechanically compliant element comprises a polymeric material, elastomeric material, rubber, silicone, polyurethane, thermoplastic polyurethane, thermoplastic elastomer, viscoelastic material, foam material, gel material, composite material, fluoropolymer, nitrile rubber, neoprene, EPDM, or any other mechanically compliant material capable of attenuating transmission of mechanical excitation, or combinations thereof.

67. The support structure of claim 61, wherein the at least one isolator comprises a polymeric material, elastomeric material, rubber, silicone, polyurethane, thermoplastic polyurethane, thermoplastic elastomer, viscoelastic material, foam material, gel material, composite material, fluoropolymer, nitrile rubber, neoprene, EPDM, or any other mechanically compliant material capable of attenuating transmission of mechanical excitation, or combinations thereof.

68. The support structure of claim 62, wherein the at least one isolator comprises a polymeric material, elastomeric material, rubber, silicone, polyurethane, thermoplastic polyurethane, thermoplastic elastomer, viscoelastic material, foam material, gel material, composite material, fluoropolymer, nitrile rubber, neoprene, EPDM, or any other mechanically compliant material capable of attenuating transmission of mechanical excitation, or combinations thereof.

69. The support structure of claim 60, wherein the passive mechanically compliant element comprises a mechanically compliant structure including a continuous sheet, pad, rail, ring, block, molded feature, elastomeric body, compressible element, compliant interface layer, lattice structure, cellular structure, web-supported structure, ribbed structure, hollow structure, monolithic structure, multi-component structure, or any other mechanically compliant structure configured to attenuate transmission of mechanical excitation, or combinations thereof.

70. The support structure of claim 61, wherein the at least one isolator comprises a mechanically compliant structure including a continuous sheet, pad, rail, ring, block, molded feature, elastomeric body, compressible element, compliant interface layer, lattice structure, cellular structure, web-supported structure, ribbed structure, hollow structure, monolithic structure, multi-component structure, or combinations thereof.

71. The support structure of claim 62, wherein the at least one isolator comprises a mechanically compliant structure including a continuous sheet, pad, rail, ring, block, molded feature, elastomeric body, compressible element, compliant interface layer, lattice structure, cellular structure, web-supported structure, ribbed structure, hollow structure, monolithic structure, multi-component structure, or combinations thereof.

72. The support structure of claim 60, wherein mechanical loads transmitted between the structural member and the energy storage device pass through the mechanical excitation attenuation barrier when the energy storage device is installed.

73. The support structure of claim 72, wherein any additional physical connections between the structural member and the energy storage device do not define a load-bearing path for transmitting mechanical loads between the structural member and the energy storage device when the energy storage device is installed.

74. The support structure of claim 72, wherein rigid mechanical bypass paths between the structural member and the energy storage device are eliminated or rendered mechanically compliant when the energy storage device is installed.

75. The support structure of claim 60, wherein the mechanical excitation attenuation barrier is configured to be structurally interposed between the structural member and the energy storage device when the energy storage device is installed such that mechanical excitation transmitted from the structural member to the energy storage device is attenuated by the passive mechanically compliant element.

76. The support structure of claim 75, wherein the mechanical excitation attenuation barrier structurally supports the energy storage device relative to the structural member when the energy storage device is installed.

77. The support structure of claim 75, wherein the mechanical excitation attenuation barrier defines a structural interface between the structural member and the energy storage device when the energy storage device is installed.

78. The support structure of claim 75, wherein mechanical loads transmitted between the structural member and the energy storage device pass through the mechanical excitation attenuation barrier when the energy storage device is installed.

79. The support structure of claim 75, wherein the passive mechanically compliant element is positioned between the structural member and the energy storage device when the energy storage device is installed.

80. The support structure of claim 60, wherein a passive isolation system formed by the structural member, the mechanical excitation attenuation barrier, and the energy storage device is configured to achieve, target, select, or maintain a natural frequency of 200 Hz or less when the energy storage device is installed.

81. The support structure of claim 60, wherein at least a portion of the mechanical excitation attenuation barrier is externally visible.

82. The support structure of claim 60, wherein at least a portion of the mechanical excitation attenuation barrier is concealed from external view.

83. The support structure of claim 60, wherein the structural member comprises a mounting structure configured to support the energy storage device.

84. The support structure of claim 60, wherein the mechanical excitation attenuation barrier is integrated into the structural member.

85. The support structure of claim 60, wherein the mechanical excitation attenuation barrier is removably coupled to the structural member such that mechanical loads transmitted between the structural member and the energy storage device pass through the passive mechanically compliant element when the energy storage device is installed.

86. The support structure of claim 60, wherein the mechanical excitation attenuation barrier occupies less than 25% of an internal volumetric capacity of the energy storage device configured to house electrochemical components when the energy storage device is installed.

87. The support structure of claim 86, wherein the internal volumetric capacity excludes external housings, covers, mounting features, and non-electrochemical structural components.
